(19) United States
(12) Patent Application Publication
(10) Pub. No.: US 2015/0056471 A1
(43) Pub. Date: Feb. 26, 2015

(54) ORDERED POROUS NANOFIBERS, METHODS, AND APPLICATIONS

(71) Applicant: CORNELL UNIVERSITY, ITHACA, NY (US)

(72) Inventors: Yong Lak Joo, Ithaca, NY (US); Ulrich Wiesner, Ithaca, NY (US); Jay Hoon Park, Ithaca, NY (US)

(73) Assignee: CORNELL UNIVERSITY, ITHACA, NY (US)

(21) Appl. No.: 14/378,249

(22) PCT Filed: Feb. 14, 2013
(86) PCT No.: PCT/US13/26060

§ 371 Date: Aug. 12, 2014

Related U.S. Application Data
(60) Provisional application No. 61/599,541, filed on Feb. 16, 2012.

(51) Int. Cl. D01F 9/08; D01F 1/08; B22F 9/06; B22F 1/00; C04B 35/622; D01D 5/00

(52) U.S. Cl. CPC D01F 9/08; C04B 35/6224; C04B 35/62236; D01D 5/0007; B22F 9/06; B22F 1/004; B22F 1/0044; D01F 1/08; B22F 2304/05
USPC 428/687; 264/414; 423/335; 423/625; 501/153; 75/345; 428/398

(57) ABSTRACT

Described herein are nanofibers and methods for making nanofibers that have a plurality of pores. The pores have of any suitable size or shape. In some embodiments the pores are “mesopores”, having a diameter between 2 and 50 nm. In some embodiments, the pores are “ordered”, meaning that they have a substantially uniform shape, a substantially uniform size and/or are distributed substantially uniformly through the nanofiber. Ordering of the pores results in a high surface area and/or high specific surface area. Ordered pores, without limitation, result in a nanofiber that is substantially flexible and/or non-brittle. The nanofibers and methods for making nanofibers may be used, without limitation, in batteries, capacitors, electrodes, solar cells, catalysts, adsorbers, filters, membranes, sensors, fabrics and/or tissue regeneration matrixes.

### CROSS-REFERENCE

This application claims the benefit of U.S. Provisional Application No. 61/599,541, filed Feb. 16, 2012, which is incorporated herein by reference in its entirety.

### BACKGROUND OF THE INVENTION

Nanotechnology is the manipulation of matter at an atomic and molecular scale and is a diverse field involving many different structures, techniques and potential applications. Of them, one structure is a nanofiber, which generally has a diameter of less than a few microns and can be of various lengths.

### SUMMARY OF THE INVENTION

Nanostructured materials, including nanofibers, have potential for applications in a wide variety of fields including high performance filtration, chemical sensing, biomedical engineering and renewable energy. Most of these applications (e.g., heterogeneous catalysis) utilize the surface of the material (e.g., nanofiber), so benefit from materials (e.g., nanofibers) with a high surface area, a high porosity, and the like. Furthermore, some applications benefit from porous nanofibers that are substantially contiguous, long, coherent, flexible, non-brittle, and the like.

Described herein are nanostructured materials, including nanofibers, and methods for making nanostructured materials, including nanofibers, that have a plurality of pores. In various embodiments, the pores are of any suitable size or shape. In some embodiments, processes described herein are useful for selectively tuning pore geometries, sizes, ordering, and the like. In some embodiments the pores are “mesopores”, having a diameter between 2 and 50 nm. In some embodiments, the material (e.g. nanofiber(s)) comprises pores that are “ordered.” In some instances, ordered pores are distributed in the material in an ordered manner. In some embodiments, materials (e.g., nanofibers with ordered pores) provided herein comprise pores having a substantially uniform shape, having a substantially uniform size and/or that are distributed substantially uniformly through the nanofiber. In some embodiments, nanofibers described herein have a high surface area and/or specific surface area (e.g., surface area per mass of nanofiber and/or surface area per volume of nanofiber). In some embodiments, materials (e.g., nanofibers) described herein comprise a plurality of pores (e.g., ordered pores) and have flexibility and/or non-brittleness (e.g., relative to otherwise identical non-porous materials). The nanostructured materials (e.g., nanofibers) and methods for making nanostructured materials (e.g., nanofibers) are optionally used in any suitable application, including without limitation, in batteries, capacitors, electrodes, solar cells, catalysts, adsorbers, filters, membranes, sensors, fabrics and/or tissue regeneration matrixes.

Provided in certain embodiments herein is a process for producing a mesoporous material (e.g., a mesoporous nanofiber), the process comprising:
a. processing a fluid stock to produce a first material (e.g., an as-spun nanofiber), the fluid stock comprising a block co-polymer;
b. optionally annealing the first material; and
c. chemically and/or thermally treating the first material to produce a mesoporous material.

In some embodiments, processing of the fluid stock comprises electrospinning the fluid stock to produce a first nanofiber. In other embodiments, processing the fluid stock comprises casting the fluid stock to produce a first cast material (e.g., a film) or spin coating the fluid stock to produce a first film material. Other material types are also optionally prepared using suitable techniques.

In some embodiments, the fluid stock further comprises metal precursor, ceramic precursor, carbon precursor, nanoparticles, or any combination thereof. In some embodiments, the fluid stock comprises (a) at least one block co-polymer and (b) a metal precursor. In certain of such embodiments, the block co-polymer and metal precursor are associated with one another in the fluid stock (e.g., when the block co-polymer is combined with the metal precursor, a condensation product of the two is formed, or a nucleophilic moiety of the copolymer may chelate with the metal of the metal precursor). In certain embodiments, the fluid stock is prepared by combining (a) at least one block co-polymer, and (b) a metal precursor. In some embodiments, the fluid stock comprises (a) at least one block co-polymer and (b) a plurality of nanoparticles. In specific embodiments, the nanoparticles comprise metal, metal oxide, ceramic, or a combination thereof.

In some embodiments, the mesoporous material (e.g., mesoporous nanofiber) described or prepared according to a process herein is a mesoporous ceramic material (e.g., a mesoporous ceramic nanofiber) comprising a continuous ceramic matrix. In various embodiments, the ceramic material comprises one or more metal type (generally in having an oxidation state of greater than zero). In some embodiments, the mesoporous material (e.g., mesoporous nanofiber) described or prepared according to a process herein is a mesoporous metal material (e.g., a mesoporous metal nanofiber) comprising a continuous metal matrix. In various embodiments, the metal material comprises one or more metal in a zero oxidation state (e.g., elemental metal or a metal alloy). In some embodiments, the mesoporous material (e.g., mesoporous nanofiber) described or prepared according to a process herein is a mesoporous metal oxide material (e.g., a mesoporous metal oxide nanofiber) comprising a continuous metal oxide matrix. In various embodiments, the metal oxide material comprises one or more metal in a oxidation state of greater than zero. In some embodiments, the mesoporous material (e.g., mesoporous nanofiber) described or prepared according to a process herein is a mesoporous polymer or carbon material (e.g., a mesoporous polymer or carbon nanofiber) comprising a continuous polymer or carbon matrix. In various embodiments, any mesoporous material describe herein optionally comprises discrete domains (e.g., nanoparticles).

In some embodiments, e.g., wherein mesoporous metal, ceramic, or metal oxide materials are being prepared, the fluid stock comprises block co-polymer and a metal precursor. In specific embodiments, the metal precursor comprises a metal halide (e.g., metal chloride), metal carboxylate (e.g., metal acetate), metal nitrate, metal diketone, a metal alkoxide (e.g., metal ethoxide), a combination thereof, or any suitable metal salt/complex (e.g., an electrophilic metal salt/complex). In certain embodiments, metal precursors (and/or metal, metal oxide, or ceramic of the mesoporous material) comprise any desired or suitable metal, e.g., one or more of the following metals: Ag, Cu, Ni, Fe, Co, Pb, Au, Sn, Al, Zr, Li, Mn, Cr, Be, Cd, Si, Ti, V, Hf, Sr, Ba, and/or Ge. In certain embodiments, e.g., wherein mesoporous metal, ceramic, or metal oxide materials are being prepared, the fluid stock comprises block copolymer and metal, ceramic, or metal oxide nanoparticles. In some embodiments, e.g., wherein mesoporous polymer or carbon materials being prepared, the fluid stock comprises block co-polymer and a carrier polymer. In certain specific embodiments, the fluid stock is prepared by combining (i) at least one block co-polymer, (ii) a sol-gel precursor (e.g., TEOS), (iii) water and/or alcohol, and (iv) an optional acid (e.g., aqueous HCl). In more specific embodiments, alcohol is used. In some specific embodiments, the fluid stock is prepared by (i) preparing a first stock by combining metal precursor and a first fluid composition (e.g., an aqueous composition, such as aqueous acetic acid); (ii) preparing a second stock by (a) combining at least one block co-polymer with a second fluid composition (e.g., water), and (b) optionally heating; and combining the first and second stocks to form a fluid stock.

In some embodiments, metal precursor is present in or provided into the fluid stock in a concentration of at least 200 mM (e.g., at least 250 mM, or at least 300 mM). In further or alternative embodiments, the block co-polymer comprises at least one hydrophilic block (e.g., at least one block that is more hydrophilic than a second block), the at least one hydrophilic block comprising a plurality of hydrophilic monomeric residues, and the metal precursor being present in or added in a metal precursor-to-hydrophilic monomeric residue ratio of about 0.1 to about 4 (e.g., about 0.25 to about 1).

In some embodiments, chemical and/or thermal treatment comprises thermal treatment of the first (e.g., as-spun or annealed) nanofiber. In some instances, thermal treatment comprises heating the first nanofiber at a temperature of at least 300° C. (e.g., at least 400° C., or at least 600° C.). In certain embodiments, thermal treatment is conducted under inert or reductive conditions (e.g., argon or argon/hydrogen atmosphere). In other embodiments, thermal treatment is conducted under oxidative conditions (e.g., air atmosphere). In certain embodiments, when metal precursors are utilized, thermal treatment performed under oxidative conditions provides mesoporous metal oxide or ceramic nanofibers. In other instances, e.g., wherein difficult to oxidize metals (e.g., Ag) are utilized, oxidative conditions lead to nanofibers comprising metal or a metal and metal oxide/ceramic mixture, alloy, or composite. In some embodiments, when metal precursors are utilized, thermal treatment performed under inert/reductive conditions provides metal nanofibers. In other instances, e.g., wherein easy to oxidize metals (e.g., Si or Al) are utilized, oxidative conditions lead to nanofibers comprising metal oxide or a metal oxide/ceramic and metal mixture, alloy, or composite.

In some embodiments, e.g., wherein mesoporous polymer or carbon materials (e.g., nanofibers) are prepared, chemically and/or thermally treating the first nanofiber comprises selectively removing at least part of the block co-polymer from the first material (e.g., nanofiber) to create a mesoporous material (e.g., nanofiber). In certain embodiments, selective removal of a block copolymer is achieved in any suitable manner, e.g., depending on the block copolymer utilized (e.g., by heating, by ozonolysis, by treating with an acid, by treating with a base, by treating with water, by combined assembly by soft and hard (CASH) chemistries, or any combination thereof). In some embodiments, removal by combined assembly soft and hard (CASH) chemistries comprises selective removal of a degradable block and/or removable block followed by selective removal of a block that does not degrade under conditions suitable for degrading and/or removing the degradable and/or removable block. In certain embodiments, e.g., wherein mesoporous carbon materials are prepared, after removal of at least part of the block-copolymer, thermal treatment of the material provides mesoporous carbon material. In some embodiments, similar procedures are optionally utilized to prepare metal and/or ceramic materials (e.g., from a fluid stock comprising metal or ceramic nanoparticles, or metal precursors). In some of such embodiments, removal by combined assembly soft and hard (CASH) chemistries comprises: (a) degrading and/or removing the first block of a block co-polymer comprising a first block and a second block, wherein at least part of the second block converts to amorphous (i.e., soft) carbon; and (b) degrading and/or removing the amorphous carbon, thereby removing the first block and the second block of the block co-polymer.

In various embodiments, any suitable bock co-polymer is utilized. In some embodiments, a suitable block co-polymer is an amphiphilic block co-polymer. In certain embodiments, a suitable block co-polymer is a block co-polymer that is a surfactant. The process of any one of the preceding claims, wherein the block co-polymer is amphiphilic (e.g., a surfactant). In certain embodiments, the block co-polymer is a di-block co-polymer comprising a first and second block, the first and second blocks being different from one another. In other embodiments, the block co-polymer is a tri-block co-polymer, comprising a first, second, and third block, wherein at least two of the blocks are different from one another. In specific embodiments, each block has a minimum of at least 10 monomeric residues. In more specific embodiments, each block has a minimum of at least 20 monomeric residues, or at least 30 monomeric residues.

In some embodiments, a suitable block co-polymer is a block copolymer comprising a first block and a second block, the first and second blocks having an affinity for themselves and/or an aversion to each other (or an insolubility in each other). In some embodiments, a suitable block co-polymer comprises a first block and a second block, wherein the first block is hydrophilic and the second block is hydrophobic or lipophilic (including, e.g., wherein the first block is more hydrophilic than the second block, or the second block is more hydrophobic than the first block). In some embodiments, the block-copolymer comprises at least one block comprising (e.g., on monomeric residues thereof) alcohol groups, ether groups, amine groups, or combinations thereof (or other nucleophilic groups).

For example, in certain embodiments, the block co-polymer comprises a polyvinyl alcohol (PVA) block, a polyethylene oxide (PEO) block, polyvinylpyridine block or any combination thereof. In certain embodiments, block co-polymers provided herein comprise (e.g., as a hydrophobic or lipophilic block) a polyimide block, a polylactic acid (PLA) block, a polypropylene oxide (PPO) block, polystyrene (PS) block, a nylon block, a polyacrylate block (e.g., poly acrylic acid, polyalkylalkacrylate—such as polymethylmethacrylate (PMMA), polyalkylacrylate, polyalkacrylate), polyacrylamide (PAA) block, polyvinylpyrrolidone (PVP) block, polyacrylonitrile (PAN), or any combination thereof. In some embodiments, the block co-polymer comprises a thermally or chemically degradable polymer block, e.g., a polyisoprene (PI) block, a polylactic acid (PLA) block, a polyvinyl alcohol (PVA) block, a polyethylene oxide (PEO) block, a polyvinylpyrrolidone (PVP) block, polyacrylamide (PAA) block or any combination thereof. In certain embodiments, the block co-polymer comprises thermally or chemically stable polymer block, e.g., a polystyrene (PS) block, a poly(methyl methacrylate) (PMMA) block, a polyacrylonitrile (PAN) block, or any combination thereof. In certain embodiments, the block co-polymer comprises a block degradable under chemical or thermal conditions, and a second block that is not degradable under such conditions.

In specific embodiments, a block co-polymer described herein is or comprises PI-b-PEO, PAN-b-PEO, PVA-b-PS, PEO-b-PPO-b-PEO, PPO-b-PEO-b-PPO, PVA-b-PEO, PVA-b-PAN, PVA-b-PPO, PI-b-PS, PEO-b-PS, PI-b-PS, PVA-PMMA, PVA-PAA, PEO-b-PMMA, or a combination thereof. In more specific embodiments, the block co-polymer comprises PI-b-PS, PS-b-PLA, PMMA-b-PLA, PI-b-PEO, PAN-b-PEO, PVA-b-PS, PEO-b-PPO-b-PEO, PPO-b-PEO-b-PPO, or any combination thereof.

In some embodiments, processing of the fluid stock comprises electrospinning the fluid stock into a first (as spun) nanofiber. In some embodiments, the fluid stock is mono-axially spun (i.e., a single fluid electrospun about an axis). In certain embodiments, the fluid stock is co-axially spun with at least one additional fluid (i.e., at least two fluids electrospun about a common axis). In some embodiments, the fluid stock is spun with a second fluid stock (e.g., comprising a carrier polymer and/or a partially gelled sol gel system) producing a coaxially layered nanofiber having a core and a shell layer. In other embodiments, the fluid stock is spun with a gas, in a gas-assisted manner. In some instances, electrospinning with gas improves electrospinning throughput and morphology. In some specific embodiments, the fluid stock is co-axially spun with at least one additional fluid stock and a gas (i.e., wherein all fluids are electrospun about a common axis).

In some embodiments, the fluid stock is electrospun with a carrier polymer. In some embodiments, the fluid stock comprises the carrier polymer. In further or alternative embodiments, the carrier polymer is present in a second fluid stock (e.g., in a polymer solution or suspension or as a neat polymer). In specific embodiments, electrospinning the fluid stock comprises coaxially electrospinning the fluid stock with a second fluid stock, the second fluid stock comprising the carrier polymer. In certain embodiments, the carrier polymer is a thermally stable polymer. In some specific embodiments, the carrier polymer is or comprises polyacrylonitrile (PAN), polyvinyl alcohol (PVA), a polyethylene oxide (PEO), polyvinylpyridine, polyisoprene (PI), polyimide, polylactic acid (PLA), a polyalkylene oxide, polypropylene oxide (PPO), polystyrene (PS), a polyarylvinyl, a polyheteroarylvinyl, a nylon, a polyacrylate (e.g., poly acrylic acid, polyalkylalkacrylate—such as polymethylmethacrylate (PMMA), polyalkylacrylate, polyalkacrylate), polyacrylamide, polyvinylpyrrolidone (PVP) block, polyacrylonitrile (PAN), polyglycolic acid, hydroxyethylcellulose (HEC), ethylcellulose, cellulose ethers, polyacrylic acid, polyisocyanate, or a combination thereof or any combination thereof. In some embodiments, the ratio of number (e.g., moles) of monomeric units of carrier polymer to number (e.g., moles) of metal precursor molecules is 1:2 to 10:1 (e.g., 1:1 to 10:1 or 2:1 to 5:1).

In certain embodiments, electrospinning the fluid stock comprises coaxially electrospinning the fluid stock with a second fluid stock. In specific embodiments, the second fluid stock comprises a coating agent (e.g., a carrier polymer) or coating agent precursor (e.g., a sol gel system—such as in sol or partially gelled form). In some embodiments, the resulting first nanofiber comprising a core layer and a sheath layer, the core layer comprising the block co-polymer. In some embodiments, the sheath layer comprises a coating agent. In specific embodiments, the sheath layer at least partially coating the core layer. In certain embodiments, the coating agent is a carrier polymer or ceramic. In specific embodiments, the ceramic is silica, e.g., formed from a sol gel system comprising TEOS/EtOH/H₂O/HCl. In some embodiments, the coating agent (sheath layer) is selectively removed from the first nanofiber (e.g., by heating, by ozonolysis, by treating with an acid, by treating with a base, by treating with water, by combined assembly by soft and hard (CASH) chemistries, or any combination thereof). In certain embodiments, the sheath layer (coating agent) is thermally stable, e.g., so as to provide structural integrity to the nanofiber upon annealing.

In certain embodiments, a carrier polymer is used to stabilize an as-spun nanofiber, e.g., when exposing the nanofiber to certain chemical or thermal conditions. In further or alternative embodiments, a carrier polymer is used to assist in electrospinning of an as-spun nanofiber. In yet further or alternative embodiments, a carrier polymer is used as a carbon source or precursor (e.g., which is converted to carbon upon sufficient thermal treatment).

In some embodiments, the process provided herein comprises annealing the first material (e.g., first nanofiber). In certain embodiments, annealing changes the internal packing structure of the material. In some embodiments, annealing increases the packing ordering of the material. In certain embodiments, annealing provides a change in the ordering of the internal structure of the material (e.g., from micelle to lamellae). In certain embodiments, annealing provides a material (e.g., nanofiber) having ordered phase elements comprising spheres, cylinders (rods), layers, channels, gyroids, or any combination thereof.

In various embodiments, annealing is performed at any suitable temperature. In some embodiments, annealing is performed at room temperature. In other embodiments, annealing is performed at a temperature of 50° C. to 300° C., e.g., 50° C. to 200° C. In specific embodiments, annealing is performed for a time sufficient to provide the internal structural organization or reorganization desired. In some embodiments, annealing is performed for 1 to 48 hours. In specific embodiments, annealing is performed for 2 to 24 hours.

In some embodiments, the pores comprise spheres, cylinders, layers, channels, gyroids, or any combination thereof. In some embodiments, the pores are helical. In some embodiments, the nanofiber comprises metal, metal alloy, ceramic, polymer, or any combination thereof.

In some embodiments, the plurality of pores has a characteristic dimension, wherein standard deviation of the characteristic dimension is at most 20% of the average value of the characteristic dimension. In some embodiments, the characteristic dimension is the diameter, width, length, longest distance passing through the center of the pore, or shortest distance passing through the center of the pore. In some embodiments, the plurality of pores have a distance between the center of a given pore and the center of the nearest pore to the given pore, and wherein the standard deviation of the distance is at most 20% of the average value of the distance.

In one aspect, described herein is a method for producing an ordered mesoporous nanofiber, the method comprising: (a) producing a nanofiber comprising a major component and a minor component; (b) annealing the nanofiber; and (c) selectively removing at least part of the minor component from the nanofiber (e.g. thereby producing an ordered mesoporous nanofiber).

In one aspect, described herein is a method for producing an ordered mesoporous nanofiber, the method comprising: (a) coaxially electrospinning a first fluid stock with a second fluid stock to produce a first nanofiber, the first fluid stock comprising at least one block co-polymer, the second fluid stock comprising a coating agent, and the first nanofiber comprising a first layer (e.g., core) and a second layer (e.g., coat) that at least partially coats the first layer; (b) annealing the first nanofiber; (c) optionally removing the second layer from the first nanofiber to produce a second nanofiber comprising the block co-polymer; and (d) selectively removing at least part of the block co-polymer from the first nanofiber or the second nanofiber (e.g. thereby producing an ordered mesoporous nanofiber).

In certain embodiments, provided herein is a nanofiber comprising a (or a plurality of nanofibers comprising an average) surface area of at least 10πrh, wherein r is the radius of the nanofiber and h is the length of the nanofiber. In some embodiments, provided herein is a nanofiber comprising a (or a plurality of nanofibers comprising an average) specific surface area of at least 10 m²/g (e.g., at least 30 m²/g, at least 100 m²/g, at least 300 m²/g, at least 500 m²/g, at least 700 m²/g, at least 800 m²/g, at least 900 m²/g, or at least 1000 m²/g, e.g., as measured by BET). In certain embodiments, provided herein is a nanofiber comprising a (or a plurality of nanofibers comprising an average) porosity of at least 20% (e.g., at least 30%, at least 40%, at least 50%) and a length of at least 1 μm. In some embodiments, provided herein is a nanofiber (or a plurality of nanofibers) comprising a plurality of mesopores, the mesopores having an average (BJH) pore diameter of 2-25 nm (e.g., 2-10 nm). In some embodiments, provided herein is a nanofiber (or a plurality of nanofibers) comprising a plurality of mesopores and a maximum incremental non-microporous (i.e., <2 nm) pore volume at an average pore diameter of less than 25 nm (e.g., less than 20 nm, less than 10 nm, less than 7 nm, less than 5 nm) (e.g., as measured by BET). In certain embodiments, provided herein is a nanofiber (or plurality of nanofibers) comprising a plurality of mesopores, the mesopores having a substantially uniform size (e.g., at least 80% of the mesoporous incremental pore volume being from mesopores having a diameter within 10 nm (or 20 nm, 10 nm, 5 nm, 3 nm) of the mesopore diameter having the maximum incremental mesoporous pore volume). In some embodiments, provided herein is a nanofiber (or plurality of nanofibers) comprising a plurality of mesopores, the mesopores ordered in a cubic-type morphology, hexagonal-type morphology, reverse hexagonal-type morphology, lamellar-type morphology, gyroid-type morphology, bi-continuous morphology, helical-type morphology, assembled micelle-type morphology, or a combination thereof. FIG. 12 illustrates a number of ordered morphologies of nanostructured materials described herein.

In certain embodiments, provided herein are nanostructured materials (e.g., nanofibers) comprising a plurality of mesopores, wherein the mesopores are distributed substantially uniformly throughout the material (e.g., nanofiber(s)). In some embodiments, such mesopores have spherical structures, cylindrical structures, helical structures, layered structures, channel structures, co-continuous structures, or any combination thereof. In various embodiments, the material (e.g., nanofiber(s)) comprises a continuous matrix of metal, metal oxide, or ceramic. In further or alternative embodiments, the material (e.g., nanofiber(s)) comprises a continuous matrix of carbon or polymer. In some embodiments, the material (e.g., nanofiber(s)) comprises a plurality of mesopores and a maximum incremental non-microporous (i.e., <2 nm) pore volume at an average pore diameter of less than 25 nm (e.g., less than 20 nm, less than 10 nm, less than 7 nm, less than 5 nm). In certain embodiments, the material (e.g., nanofiber(s)) comprises a plurality of mesopores, at least 80% of the mesoporous incremental pore volume being from mesopores having a diameter within 10 nm of the mesopore diameter having the maximum incremental mesoporous pore volume. In some embodiments, the material (e.g., nanofiber(s)) comprises a plurality of mesopores, at least 80% of the mesoporous incremental pore volume being from mesopores having a diameter within 10 nm (e.g., within 7 nm, within 3 nm) of the mesopore diameter having the maximum incremental mesoporous pore volume. In certain embodiments, the material (e.g., nanofiber(s)) comprises a plurality of mesopores, at least 80% of the mesoporous incremental pore volume being from mesopores having a diameter within 50% (e.g., within 33%, within 20%) of the size of the mesopore diameter having the maximum incremental mesoporous pore volume.

In one aspect, described herein are the nanofiber produced by a step or method of any of the methods described herein.

In one aspect, described herein is a composition comprising a plurality of nanofibers described herein. In certain aspects, provided herein is a plurality of nanofibers comprising an average of any of the characteristic described herein for a single nanofiber.

In one aspect, described herein is a composition comprising a plurality of the nanofibers described herein, wherein the nanostructured material (e.g., plurality of nanofibers) comprise a specific surface area of at least 10 m²/g (e.g., at least 100 m²/g). In specific aspects, provided herein is a nanostructured material (e.g., plurality of nanofibers) having a specific surface area of at least 50 m²/g (e.g., at least 700 m²/g). In specific aspects, provided herein is a nanostructured material (e.g., plurality of nanofibers) having a specific surface area of at least 100 m²/g (at least 1000 m²/g).

In one aspect, described herein is a system comprising: (a) a fluid stock comprising block co-polymer, wherein the fluid stock optionally comprises metal and/or ceramic (sol gel) precursor; (b) an optional second fluid stock comprising a coating agent; (c) an electrospinner; (d) a nanofiber collection module; and (e) a heater, wherein the system is suitable for producing ordered mesoporous nanofibers.

In some embodiments, the electrospinner is configured to be gas-assisted.

In one aspect, described herein is a battery, capacitor, electrode, solar cell, catalyst, adsorber, filter, membrane, sensor, fabric, or tissue regeneration matrix comprising the nanofibers described herein.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 illustrates one embodiment of a schematic (a), and TEM images of microtomed cross sections (b)-(e) of a helical domain in a nanofiber.

FIG. 2 illustrates one embodiment of the self-organization of a block co-polymer in the presence of nanoparticles that are predicted by coarse-grained Molecular Dynamics simulation.

FIG. 3 illustrates one embodiment of TEM images of microtomed cross sections (top) and sections parallel to the fiber axis (bottom) for thermal annealing of PS-b-PI nanofibers over time (left to right) and after removal of the silica coating (right-most panels).

FIG. 4 illustrates one embodiment of predicted mesopore morphologies (shown in gray) in nanofibers at three different ratios of fiber diameter (D) to assembly domain length (Lₒ).

FIG. 5 illustrates one embodiment of TEM images (top) and coarse grained molecular dynamic simulations (bottom) for aggregated magnetite nanoparticles in PS-b-PI film (left) and uniformly dispersed magnetite nanoparticles in PS-b-PI nanofiber (right).

FIG. 6 illustrates one embodiment of TEM images of PS-b-PI nanofibers, optionally comprising well-dispersed magnetite nanoparticles.

FIG. 7 illustrates one embodiment of combined soft and hard (CASH) chemistries strategy for ordered mesopore formation.

FIG. 8 illustrates one embodiment of a system and method for producing mesoporous polymeric nanofibers via chemical treatment or ozonolysis.

FIG. 9 illustrates one embodiment of a system and method for producing mesoporous metallic and ceramic nanofibers with thermal treatments.

FIG. 10 illustrates one embodiment of a system and method for producing mesoporous carbon nanofibers via gas-assisted electrospinning.

FIG. 11 illustrates co-axial electrospinning apparatus, having an inner needle and an outer needle coaxially aligned about a common axis. In some instances, the inner and outer needles are configured to coaxially electrospin a first (core) layer and second (e.g., shell or coat) layer. In other instances, the inner and outer needles are configured to electrospin a first fluid stock along with a gas (e.g., in a gas assisted manner when the gas is in the outer layer or to provide hollow nanofibers when the gas is in the inner/core layer).

FIG. 12 illustrates a number of ordered morphologies of nanostructured materials (i.e. micelles) described herein.

FIG. 13 illustrates an SEM for the as-spun nanofiber having a shell layer of PVA and a core layer of a TEOS sol gel system combined with a PEO-PPO-PEO tri-block copolymer.

FIG. 14 illustrates an SEM of mesoporous silica nanofibers prepared according to a process described herein.

FIG. 15 illustrates microtomed nanofiber TEM images of mesoporous silica nanofibers prepared according to a process described herein.

FIG. 16 illustrates TEM images of cross-sectional (panel A) and longitudinal-sectional (panel B) of mesoporous silica nanofibers prepared according to a process described herein.

FIG. 17 illustrates an SEM mesoporous silica prepared using block copolymers P123 (panel A) and F127 (panel B).

FIG. 18 illustrates mesoporous silica films prepared from P123 (panel A) and F127 (panel B).

FIG. 19 illustrates pore distribution results (from BET analysis) of silica with ordered mesopores prepared from various block co-polymer concentrations.

FIG. 20 illustrates pore distribution results (from BET analysis) of porous silica prepared from various polymer concentrations.

FIG. 21 illustrates a TEM image of mesoporous alumina nanofibers prepared according to the processes described herein.

FIG. 22 illustrates a TEM image of alumnia nanofiber with silver crystals prepared according to the processes described herein.

FIG. 23 illustrates TEM images of mesoporous silica prepared according to the processes described herein. Panel A illustrates a material prepared from a mol Si:mol EO of 0.476; panel B illustrates a material prepared from a mol Si:mol EO of 0.238.

FIG. 24 illustrates the elemental EDX (Energy-Dispersive X-ray) analysis of nanostructured silica materials prepared according to a process described herein with a mol Si:mol EO ratio of 0.476.

FIG. 25 illustrates nanostructured alumina from aluminum acetate, with a mol Al:mol EO ratio of about 0.5.

FIG. 26 illustrates the incremental (panel A) and cumulative (panel B) pore volumes of the nanofibers and films prepared from homopolymer fluid stocks.

FIG. 27 illustrates the incremental (panel A) and cumulative (panel B) pore areas of nanofibers and films prepared from homopolymer fluid stocks.

FIG. 28 illustrates the incremental (panel A) and cumulative (panel B) pore volumes of the porous nanofibers prepared from a P123 containing fluid stock.

FIG. 29 illustrates the incremental (panel A) and cumulative (panel B) pore areas of the nanofibers prepared from a F127 containing fluid stock.

### DETAILED DESCRIPTION OF THE INVENTION

Described herein are nanostructured materials (e.g., nanofibers) and methods for making high surface area nanostructured materials (e.g., nanofibers) and/or nanostructured materials (e.g., nanofibers) that have a plurality of pores. The pores may be of any suitable size. In some embodiments the pores are “mesopores”, having a diameter between 2 and 50 nm. In some embodiments, the pores are “micropores”, having a diameter of less than 2 nm. In yet other embodiments, the pores are “macropores”, having a diameter greater than 50 nm. However nanofibers having pores of any size, and methods for making nanofibers having pores of any size, are within the scope of the disclosure provided herein. In some embodiments, the nanofibers described herein comprise a plurality of ordered pores. In further or alternative embodiments, the nanofibers described herein are porous nanofibers having a high surface area. In specific embodiments, the nanofibers described herein are porous nanofibers having ordered pores and a high surface area.

### Pores

In some embodiments, described herein are nanostructured materials (e.g., nanofibers) comprising a plurality of pores (e.g., mesopores). In specific embodiments, such pores are ordered (e.g., present in the nanofiber in a non-random configuration). In some embodiments, ordered pores have a substantially uniform shape, a substantially uniform size, are distributed substantially uniformly in the nanofiber, or any combination thereof. In one aspect, ordered pores provide a nanostructured material (e.g., nanofiber) having a higher surface area, a more contiguous nanostructured material (e.g., nanofiber), a more flexible nanostructured material (e.g., nanofiber) and/or less brittle nanostructured material (e.g., nanofiber) when compared with a nanostructured material (e.g., nanofiber) lacking pores, or lacking ordered pores, but of an otherwise similar or identical material.

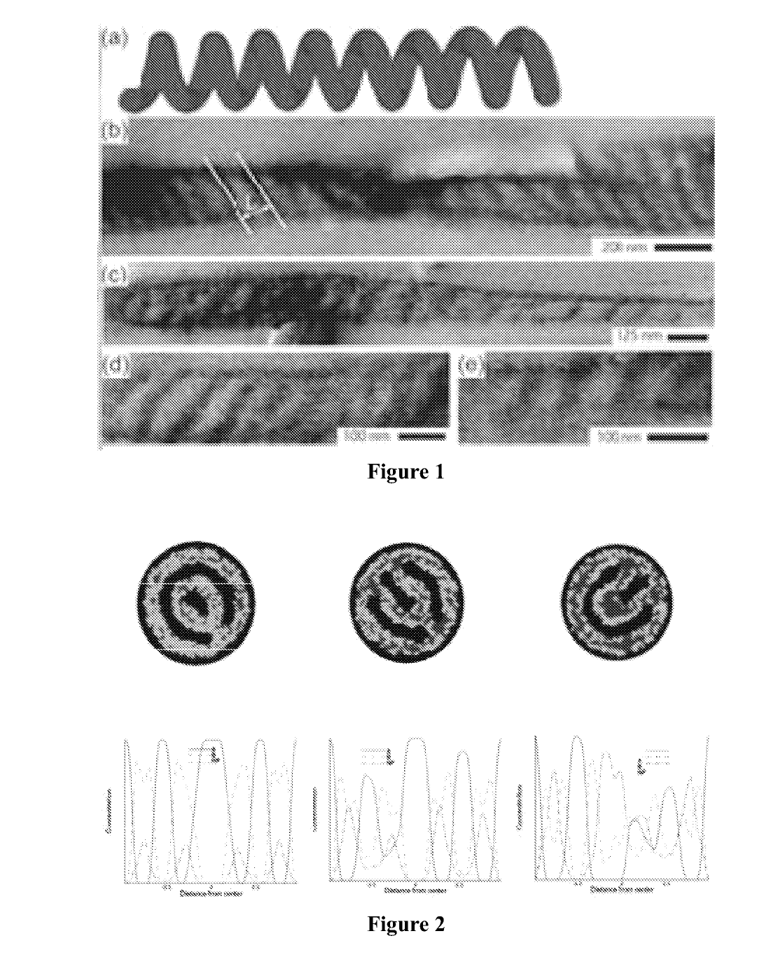

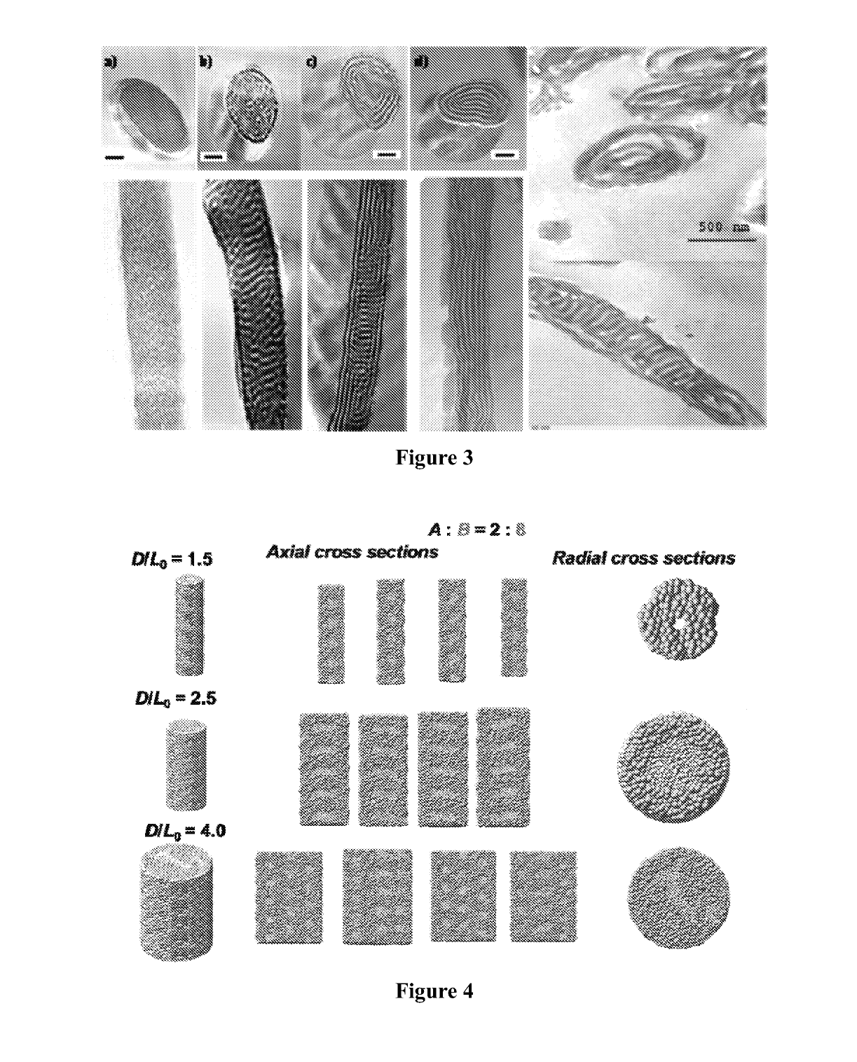

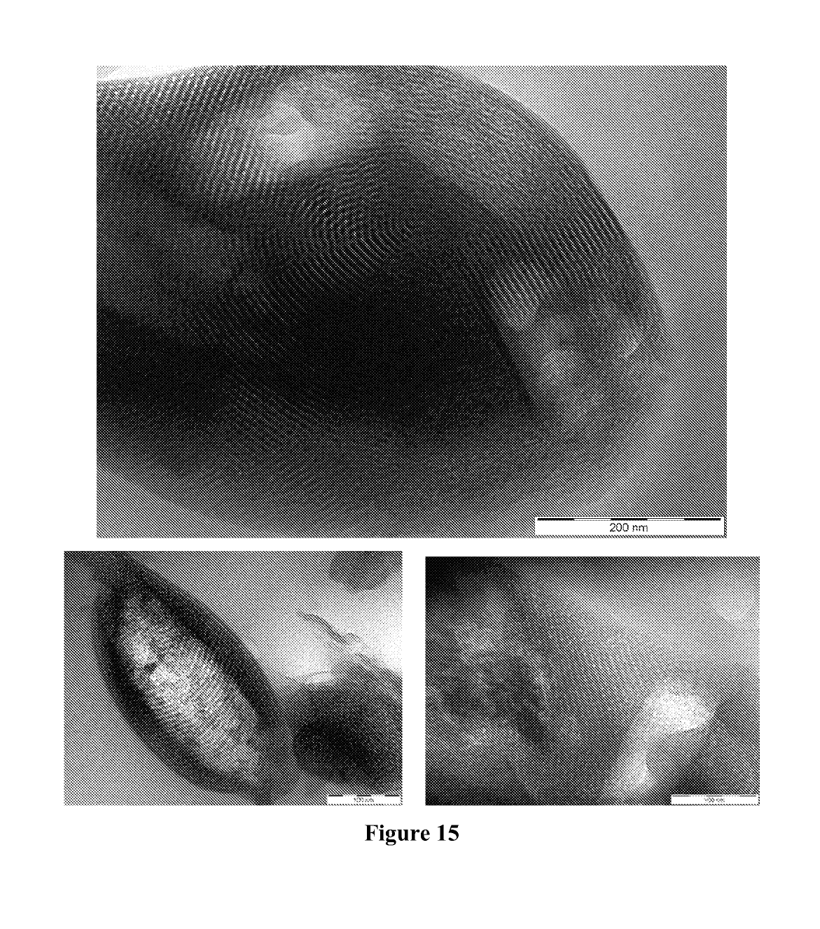

The pores and arrangement of the pores optionally have any suitable shape. Exemplary shapes include spheres, ovoids, ovals, cubes, cylinders, cones, polyhedrons (e.g., a three dimensional geometry with any number of flat faces and straight edges), layers (e.g., as illustrated in FIGS. 3b, 3c and 3d), channels, gyroids, geometric shapes, non-geometric shapes, or any combination thereof. In some embodiments, the pore(s) form a helical channel in a cylindrical nanofiber such that the nanofiber is a helical nanofiber (e.g., FIG. 1). Additional exemplary shapes include axially aligned concentric cylinders and radially aligned stacked donuts. FIGS. 1-6, 12, 15, etc. illustrate various order nanofiber morphologies. In some embodiments, the pores (e.g., mesopores) are ordered in a cubic-type morphology, hexagonal-type morphology, reverse hexagonal-type morphology, lamellar-type morphology, bi-continuous morphology, helical-type morphology, assembled micelle-type morphology (e.g., as illustrated in FIG. 15), a gyroid morphology or a combination thereof.

Various shaped pores can have various “characteristic dimensions”. For example, one characteristic dimension of a pore is its diameter (i.e., any straight line segment that passes through the center of the spherical pore and whose endpoints are on the edges of the pore). Other characteristic dimensions of a pore may include its radius, circumference, volume, depth, and the like. Since nanofibers having pores of any shape and methods for making nanofibers with pores of any shape are described here, in some embodiments, the characteristic dimension can be other than a diameter. Exemplary characteristic dimensions include the width, thickness, or length of the pore. The characteristic distance can also be the longest distance passing through the center of the pore or the shortest distance passing through the center of the pore. The characteristic dimension can be any suitable measurement represented in units of length.

In some embodiments, the pores have an average characteristic dimension of about 0.1 nm, about 0.5 nm, about 1 nm, about 2 nm, about 5 nm, about 10 nm, about 25 nm, about 50 nm, about 100 nm, about 200 nm, about 500 nm, and the like. In some embodiments, the pores have an average characteristic dimension of at least 0.1 nm, at least 0.5 nm, at least 1 nm, at least 2 nm, at least 5 nm, at least 10 nm, at least 25 nm, at least 50 nm, at least 100 nm, at least 200 nm, at least 500 nm, and the like. In some embodiments, the pores have an average characteristic dimension of at most 0.1 nm, at most 0.5 nm, at most 1 nm, at most 2 nm, at most 5 nm, at most 10 nm, at most 25 nm, at most 50 nm, at most 100 nm, at most 200 nm, at most 500 nm, and the like.

In specific embodiments, pores of nanostructures provided herein have an average diameter of 2-50 nm (i.e., mesoporous). In some embodiments, nanostructures provided herein comprise a plurality of mesoporous structures. In some embodiments, the plurality of mesoporous structures have an average diameter of 2-20 nm. In specific embodiments, the plurality of mesoporous structures have an average diameter of 2-15 nm. In more specific embodiments, the plurality of mesoporous structures have an average diameter of 2-10 nm. In some embodiments, the mesopores have a maximum incremental pore volume at an average pore diameter of less than 20 nm. In some embodiments, the mesopores have a maximum incremental pore volume at an average pore diameter of less than 15 nm. In some embodiments, the mesopores have a maximum incremental pore volume at an average pore diameter of less than 10 nm. In some embodiments, the mesopores have a maximum incremental pore volume at an average pore diameter of less than 8 nm, 6 nm, 5 nm, or the like.

In some embodiments, provided herein are nanofibers (e.g., nanofibers comprising mesopores or ordered mesopores) having a cumulative pore area (e.g., cumulative mesopore area) of at least 100 m²/g (e.g., as measured by BJH). In specific embodiments, provided herein are nanofibers (e.g., nanofibers comprising mesopores or ordered mesopores) having a cumulative pore area (e.g., cumulative mesopore area) of at least 125 m²/g. In more specific embodiments, provided herein are nanofibers (e.g., nanofibers comprising mesopores or ordered mesopores) having a cumulative pore area (e.g., cumulative mesopore area) of at least 140 m²/g. In still more specific embodiments, provided herein are nanofibers (e.g., nanofibers comprising mesopores or ordered mesopores) having a cumulative pore area (e.g., cumulative mesopore area) of at least 150 m²/g. In some embodiments, provided herein are nanofibers (e.g., nanofibers comprising mesopores or ordered mesopores) having a cumulative pore area (e.g., cumulative mesopore area) of at least 170 m²/g. In some embodiments, provided herein are nanofibers (e.g., nanofibers comprising mesopores or ordered mesopores) having an incremental pore area for a specific mesopore size that is at least as great as the incremental pore area for that mesopore size as found in either of Tables 4 or 5.

In some embodiments, provided herein are nanofibers (e.g., nanofibers comprising mesopores or ordered mesopores) having a cumulative pore volume (e.g., cumulative mesopore volume) of at least 0.09 cm³/g (e.g., as measured by BJH). In specific embodiments, provided herein are nanofibers (e.g., nanofibers comprising mesopores or ordered mesopores) having a cumulative pore volume (e.g., cumulative mesopore volume) of at least 0.10 cm³/g (e.g., as measured by BJH). In more specific embodiments, provided herein are nanofibers (e.g., nanofibers comprising mesopores or ordered mesopores) having a cumulative pore volume (e.g., cumulative mesopore volume) of at least 0.11 cm³/g (e.g., as measured by BJH). In still more specific embodiments, provided herein are nanofibers (e.g., nanofibers comprising mesopores or ordered mesopores) having a cumulative pore volume (e.g., cumulative mesopore volume) of at least 0.12 cm³/g (e.g., as measured by BJH). In some embodiments, provided herein are nanofibers (e.g., nanofibers comprising mesopores or ordered mesopores) having an incremental pore volume for a specific mesopore size that is at least as great as the incremental pore volume for that mesopore size as found in either of Tables 4 or 5.

In some embodiments, a nanofiber (e.g., nanofibers comprising mesopores or ordered mesopores) provided herein has a surface area (e.g., as measured by BET) of at least 100 m²/g. In specific embodiments, a nanofiber (e.g., nanofibers comprising mesopores or ordered mesopores) provided herein has a surface area (e.g., as measured by BET) of at least 250 m²/g. In more specific embodiments, a nanofiber (e.g., nanofibers comprising mesopores or ordered mesopores) provided herein has a surface area (e.g., as measured by BET) of at least 400 m²/g. In yet more specific embodiments, a nanofiber (e.g., nanofibers comprising mesopores or ordered mesopores) provided herein has a surface area (e.g., as measured by BET) of at least 500 m²/g. In still more specific embodiments, a nanofiber (e.g., nanofibers comprising mesopores or ordered mesopores) provided herein has a surface area (e.g., as measured by BET) of at least 500 m²/g.

In some embodiments, pore diameters are measured using any suitable technique. In exemplary embodiments, surface area, pore size, volume, diameter, or the like is optionally measured by transmission electron microscopy (TEM), scanning electron microscopy (SEM), by Brunauer-Emmett-Teller (BET) surface area analysis, by Barrett-Joyner-Halenda (BJH) pore size and volume analysis, or the like.

In some embodiments, the nanostructured materials (e.g., nanofibers) have pores with a (substantially) uniform shape, e.g., they are mostly all spheres, mostly all cubes, and the like. In some embodiments, (substantially) uniform shapes include at least 50%, at least 60%, at least 70%, at least 80%, at least 90%, at least 95%, or at least 99% of the pores are a given shape. A pore may deviate from an ideal sphere by a certain amount and still be considered a “sphere”, for example. The deviation may be by as much as 1%, 5%, 10%, 20%, or 50% for example (e.g., the diameter of a spherical pore when measured in one direction may be 20% greater than the diameter of the pore when measured in a second direction and still be considered a “sphere”). In some embodiments, the pores can be a plurality of shapes including without limitation a mixture of 2, 3, 4, or 5 shapes.

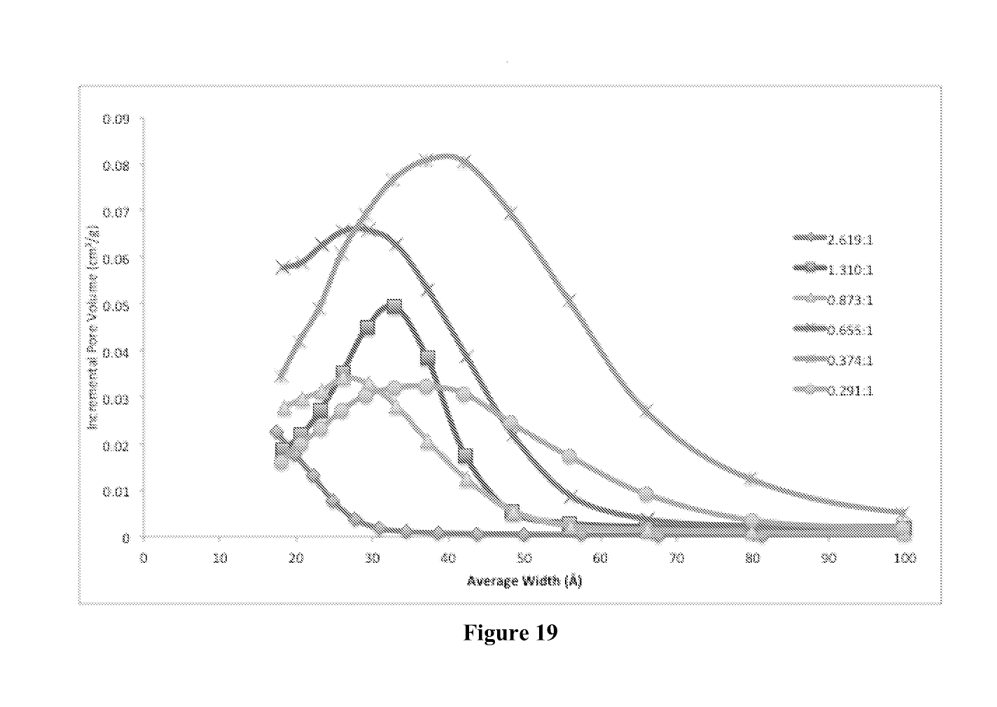

In certain embodiments, the nanostructures comprise a plurality of mesopores, at least 50%, at least 70%, at least 80%, or at least 90% of the mesoporous incremental pore volume being from mesopores having a diameter within 10 nm, 8 nm, 6 nm, 5 nm, 4 nm, 3 nm, 2 nm, 200%, 100%, 50%, 33%, 25%, or the like of the mesopore diameter having the maximum incremental mesoporous pore volume (e.g., as determined using a BET distribution chart, such as illustrated in FIG. 19). In certain embodiments, the nanostructures comprise a plurality of mesopores, at least 80% of the mesoporous incremental pore volume being from mesopores having a diameter within 10 nm of the mesopore diameter having the maximum incremental mesoporous pore volume. In certain embodiments, the nanostructures comprise a plurality of mesopores, at least 80% of the mesoporous incremental pore volume being from mesopores having a diameter within 5 nm of the mesopore diameter having the maximum incremental mesoporous pore volume. In certain embodiments, the nanostructures comprise a plurality of mesopores, at least 80% of the mesoporous incremental pore volume being from mesopores having a diameter within 8, 6, 4, 3, or 2 nm of the mesopore diameter having the maximum incremental mesoporous pore volume. In some embodiments, the nanostructures comprise a plurality of mesopores, at least 80% of the mesoporous incremental pore volume being from mesopores having a diameter within 200% of the mesopore diameter having the maximum incremental mesoporous pore volume. In some embodiments, the nanostructures comprise a plurality of mesopores, at least 80% of the mesoporous incremental pore volume being from mesopores having a diameter within 150% of the mesopore diameter having the maximum incremental mesoporous pore volume. In some embodiments, the nanostructures comprise a plurality of mesopores, at least 80% of the mesoporous incremental pore volume being from mesopores having a diameter within 50% of the mesopore diameter having the maximum incremental mesoporous pore volume. In some embodiments, the nanostructures comprise a plurality of mesopores, at least 80% of the mesoporous incremental pore volume being from mesopores having a diameter within 33% of the mesopore diameter having the maximum incremental mesoporous pore volume. In some embodiments, the nanostructures comprise a plurality of mesopores, at least 80% of the mesoporous incremental pore volume being from mesopores having a diameter within 25% of the mesopore diameter having the maximum incremental mesoporous pore volume.

In some embodiments, the pores have a substantially uniform size. The plurality of pores has a characteristic dimension as described herein. In some embodiments, the pores are of a substantially uniform size when the standard deviation of the characteristic dimension is about 5%, about 10%, about 15%, about 20%, about 30%, about 50%, about 100%, and the like of the average value of the characteristic dimension. In some embodiments, the pores are of a substantially uniform size when the standard deviation of the characteristic dimension is at most 5%, at most 10%, at most 15%, at most 20%, at most 30%, at most 50%, at most 100%, and the like of the average value of the characteristic dimension. In some embodiments, the pores do not have a substantially uniform size.

In some embodiments, the pores are distributed substantially uniformly throughout the nanofiber. Each pore of the plurality of pores will be separated from its nearest neighboring pore by a certain distance (i.e., “separation distance”). In some embodiments, the separation distance is measured from the center of one pore to the center of the nearest pore, from the center of one pore to the nearest boundary edge of the nearest pore, from the edge of one pore to the nearest boundary edge of the nearest pore, and the like. A plurality of pores will have a plurality of these “separation distances”. In some embodiments, the pores are distributed substantially uniformly throughout the nanofiber when the standard deviation of the separation distances is about 5%, about 10%, about 15%, about 20%, about 30%, about 50%, about 100%, and the like of the average separation distance. In some embodiments, the pores are distributed substantially uniformly throughout the nanofiber when the standard deviation of the separation distances is at most 5%, at most 10%, at most 15%, at most 20%, at most 30%, at most 50%, at most 100%, and the like of the average separation distance.

Nanofibers with a High Surface Area

In various aspects, the nanostructured materials (e.g., nanofibers) have a high surface area and methods are described for making nanofibers having a high surface area. In some instances, ordering of the pores results in a higher surface area and/or specific surface area (e.g., surface area per mass of nanofiber and/or surface area per volume of nanofiber). For example, in some instances, ordering of the nanofibers allows for greater pore packing/concentration in the nanostructured material (e.g., nanofiber). In some embodiments, the nanostructured materials (e.g., porous nanofibers) have a specific surface area of about 10 m²/g, about 50 m²/g, about 100 m²/g, about 200 m²/g, about 500 m²/g, about 1,000 m²/g, about 2,000 m²/g, about 5,000 m²/g, about 10,000 m²/g, and the like. In some embodiments, the porous nanofibers have a specific surface area of at least 10 m²/g, at least 50 m²/g, at least 100 m²/g, at least 200 m²/g, at least 500 m²/g, at least 1,000 m²/g, at least 2,000 m²/g, at least 5,000 m²/g, at least 10,000 m²/g, and the like. In specific embodiments, the porous nanofibers have a specific surface area of at least 100 m²/g. In more specific embodiments, the porous nanofibers have a specific surface area of at least 300 m²/g. In still more specific embodiments, the porous nanofibers have a specific surface area of at least 500 m²/g. In yet more specific embodiments, the porous nanofibers have a specific surface area of at least 700 m²/g. In still more specific embodiments, the porous nanofibers have a specific surface area of at least 800 m²/g. In more specific embodiments, the porous nanofibers have a specific surface area of at least 1000 m²/g.

In some embodiments, the porous nanofibers are cylindrical. Neglecting the area of the two circular ends of a cylinder, the area of the cylinder is estimated to be two times the mathematical constant pi (π) times the radius of the cross section of the cylinder (r) times the length of the nanofiber (h), (i.e., 2πrh). In some embodiments, the surface area of the porous nanofiber is greater than 2πrh. In some embodiments, the surface area of the porous nanofiber is about 4πrh, about 10πrh, about 20πrh, about 50πrh, about 100πrh, and the like. In some embodiments, the surface area of the porous nanofiber is at least 4πrh, at least 10πrh, at least 20πrh, at least 50πrh, at least 100πrh, and the like.

In one aspect, described herein are nanofibers having a high porosity. Also described herein are methods for making nanofibers with a high porosity. “Porosity” is used interchangeably with “void fraction” and is a measure of the porous spaces in a material. Porosity is the fraction of the sum total volume of the pores divided by the total volume. In some embodiments the total volume used in the calculation of porosity is the volume occupied by a collection of porous nanofibers (e.g., fibers arranged as a filter mat). In some embodiments, the total volume used in the calculation of porosity is the volume defined by the outer perimeter of a porous nanofiber. For example, the total volume of a cylindrical nanofiber is estimated to be the mathematical constant pi (π) times the square of the radius of the cross section of the cylinder (r²) times the length of the nanofiber (h), (i.e., πr²h). Porosity is represented as a percentage ranging from 0% to 100%.

The porosity of the nanofibers described herein can be any suitable value. In some embodiments, the porosity is about 1%, about 5%, about 10%, about 20%, about 25%, about 30%, about 35%, about 40%, about 45%, about 50%, about 55%, about 60%, about 70%, about 80%, and the like. In some embodiments, the porosity is at least 1%, at least 5%, at least 10%, at least 20%, at least 25%, at least 30%, at least 35%, at least 40%, at least 45%, at least 50%, at least 55%, at least 60%, at least 70%, at least 80%, and the like.

The nanofibers described herein, and the methods for making the nanofibers described herein have ordered pores in some embodiments. Without being bound by theory, ordered pores allow for a nanofiber to have both a high porosity and be long, contiguous, flexible and/or non-brittle (i.e., be high quality porous nanofibers). Such high quality nanofibers would be statistically more likely to be long because the chances are reduced that there is a pore, or combination of pores along any particular portion of the length that is large enough (i.e., not ordered) to define an end of the nanofiber.

In one aspect, the nanofiber has a high porosity and is long. Methods for measuring the length of a nanofiber include, but are not limited to microscopy, optionally transmission electron microscopy (“TEM”) or scanning electron microscopy (“SEM”). The nanofiber can have any suitable length. A given collection of nanofibers would be expected to have nanofibers that have a distribution of fibers of various lengths. Therefore, certain fibers of a population may accordingly exceed or fall short of the average length. In some embodiments, the nanofiber has an average length of about 1 μm, about 5 μm, about 10 μm, about 20 μm, about 50 μm, about 100 μm, about 500 μm, about 1,000 μm, about 5,000 μm, about 10,000 μm, about 50,000 μm, about 100,000 μm, about 500,000 μm, and the like. In some embodiments, the nanofiber has an average length of at least about 1 μm, at least about 5 μm, at least about 10 μm, at least about 20 μm, at least about 50 μm, at least about 100 μm, at least about 500 μm, at least about 1,000 μm, at least about 5,000 μm, at least about 10,000 μm, at least about 50,000 μm, at least about 100,000 μm, at least about 500,000 μm, and the like. In some embodiments, the nanofiber has any of these (or other suitable) lengths in combination with any of the porosities described herein (e.g., 20%).

In one aspect, the nanofiber has a high porosity and is substantially contiguous. A nanofiber is substantially contiguous if when following along the length of the nanofiber, fiber material is in contact with at least some neighboring fiber material over substantially the entire nanofiber length. “Substantially” the entire length means that at least 80%, at least 90%, at least 95%, or at least 99% of the length of the nanofiber is contiguous. In some embodiments, the nanofiber is substantially contiguous in combination with any of the porosities described herein (e.g., 35%).

In one aspect, the nanofiber has a high porosity and is substantially flexible or non-brittle. Flexible nanofibers are able to deform when a stress is applied and optionally return to their original shape when the applied stress is removed. A substantially flexible nanofiber is able to deform by at least 5%, at least 10%, at least 20%, at least 50%, and the like in various embodiments. A non-brittle nanofiber does not break when a stress is applied. In some embodiments, the nanofiber bends (e.g., is substantially flexible) rather than breaks. A substantially non-brittle nanofiber is able to deform by at least 5%, at least 10%, at least 20%, at least 50%, and the like without breaking in various embodiments. In some embodiments, the nanofiber is substantially flexible or non-brittle in combination with any of the porosities described herein (e.g., 35%).

In one aspect, described herein are nanofibers comprising any one or more of: (a) a surface area of at least 10πrh, wherein r is the radius of the nanofiber and h is the length of the nanofiber; (b) a specific surface area of at least 100 m²/g; (c) a porosity of at least 20% and a length of at least 1 μm; (d) a porosity of at least 35%, wherein the nanofiber is substantially contiguous; (e) a porosity of at least 35%, wherein the nanofiber is substantially flexible or non-brittle; (f) a plurality of pores with an average diameter of at least 1 nm; (g) a plurality of pores, wherein the pores have a substantially uniform shape; (h) a plurality of pores, wherein the pores have a substantially uniform size; and (i) a plurality of pores, wherein the pores are distributed substantially uniformly throughout the nanofiber.

### Nanofiber Materials

In various embodiments, the nanostructured materials (e.g., nanofibers) described herein comprise any suitable material. In various embodiments, the methods described herein are used to make nanofibers comprising any suitable material. Exemplary materials include metal (e.g., comprising a single/pure metal, a metal mixture, or a metal alloy), metal oxide (e.g., comprising one or more metal type) (e.g., ceramic metal oxide), ceramic, polymer, carbon, or any combination thereof (e.g., hybrid nanofibers of various metals and/or ceramics).

In certain embodiments, nanostructured materials (e.g., nanofiber(s)) provided herein comprise porous (e.g., mesoporous) polymer material (e.g., nanofiber(s)). In some embodiments, the nanostructured material (e.g., nanofiber(s)) comprise a continuous matrix of polymer. In specific embodiments, the polymer material comprises one or more residual block of a block co-polymer (e.g., a block co-polymer used in the preparation of a nanofiber, wherein at least one of the blocks is subsequently selectively removed) or a carrier polymer, described herein. In certain embodiments, the polymer material comprises polyvinyl alcohol (PVA), polyethylene oxide (PEO), polyvinylpyridine, polyisoprene (PI), polyimide, polylactic acid (PLA), polypropylene oxide (PPO), polystyrene (PS), a nylon, a polyacrylate (e.g., poly acrylic acid, polyalkylalkacrylate—such as polymethylmethacrylate (PMMA), polyalkylacrylate, polyalkacrylate), polyacrylamide (PAA), polyvinylpyrrolidone (PVP), polyacrylonitrile (PAN), a polyalkylene oxide, a polyarylvinyl, a polyheteroarylvinyl, ethylcellulose, a cellulose ether, polyisocyanate, or a combination thereof or any combination thereof.

In some embodiments, nanostructured materials (nanofiber(s)) described herein comprises porous (e.g., mesoporous) carbon (e.g., amorphous or graphitic carbon). In certain embodiments, the nanostructured material (nanofiber) comprises a continuous matrix of carbon (e.g., constitutes a connective material of a nanofiber). In certain embodiments, the carbon is a residue provided from thermal treatment (calcination) of an as-prepared (e.g., as-spun) first material (e.g., nanofiber) as described herein. In some embodiments, the carbon is a residue of the block co-polymer or a carbon precursor, such as a carrier polymer.

In some applications, pure metal or ceramic nanofibers have attractive properties such as high conductivity for use in devices such as batteries, ultracapacitors, solar cells, and the like. They are also useful in the field of catalysis on account of the high surface area to volume ratio of a nanofiber. Additional disclosure regarding methods and fluid stocks for producing metal, ceramic, metal alloy and hybrid nanofibers including methods for calcinating nanofibers are described in International Patent Application PCT/US12/53097, filed Aug. 30, 2012, U.S. patent application Ser. No. 13/451,960, filed Apr. 20, 2012, and published as US 2012/0282484 on Nov. 8, 2012, and U.S. Provisional Patent Application 61/528,895 filed on Aug. 30, 2011, each of which is incorporated herein for such disclosure.

Provided in certain embodiments herein are nanostructured materials (e.g., nanofibers) comprising a metal component (e.g., a metal, metal oxide, or a combination thereof). In some embodiments, nanostructured materials (e.g., nanofibers) are pure metal component materials (e.g., nanofibers), nanostructured materials (e.g., nanofibers) comprising metal component (e.g., metal or metal oxide), or nanostructured materials (e.g., nanofibers) substantially comprised or consisting essentially of metal component (e.g., metal or metal oxide). In various embodiments, the metal component containing nanostructured materials (e.g., nanofibers) have any suitable percent composition of metal. In some embodiments, the nanostructured material (e.g., nanofiber) comprises (e.g., on average for a plurality of nanofibers) about 99.99%, about 99.95%, about 99.9%, about 99%, about 98%, about 97%, about 96%, about 95%, about 90%, about 80%, and the like of metal by mass. In some embodiments, the nanostructured material (e.g., nanofiber) comprises (e.g., on average for a plurality of nanofibers) at least about 99.99%, at least about 99.95%, at least about 99.9%, at least about 99%, at least about 98%, at least about 97%, at least about 96%, at least about 95%, at least about 90%, at least about 80%, and the like of metal by mass. In specific embodiments, nanostructured materials, e.g., nanofibers, described herein comprises a continuous matrix of a metal component (e.g., metal, metal oxide, ceramic, etc.). In various embodiments, the metal of a metal component (e.g., metal or metal oxide) is any suitable metal, including: transition metal, alkali metal, alkaline earth metal, post-transition metal, lanthanide, or actinide (or metalloid). In some instances, suitable transition metals include: scandium (Sc), titanium (Ti), vanadium (V), chromium (Cr), manganese (Mn), iron (Fe), cobalt (Co), nickel (Ni), copper (Cu), zinc (Zn), yttrium (Y), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), gold (Au), mercury (Hg), rutherfordium (Rf), dubnium (Db), seaborgium (Sg), bohrium (Bh), and hasium (Hs). In some instances, suitable alkali metals include: lithium (Li), sodium (Na), potassium (K), rubidium (Rb), cesium (Cs) and francium (Fr). In certain instances, suitable alkaline earth metals include: beryllium (Be), magnesium (Mg), calcium (Ca), strontium (Sr), barium (Ba), and radium (Ra). In some instances, suitable post-transition metals include: aluminum (Al), gallium (Ga), indium (In), tin (Sn), thallium (Tl), lead (Pb), and bismuth (Bi). In some instances, suitable lanthanides include the elements with atomic number 57 to 71 on the periodic table. In certain instances, suitable actinides include the elements with atomic number 89 to 103 on the periodic table. In certain embodiments, the metal is a metalloid, such as germanium (Ge), antimony (Sb), polonium (Po), or silicon (Si).

Provided in certain embodiments herein are nanostructured materials (e.g., nanofibers) comprising a ceramic component (e.g., a single or mixed metal oxide ceramic). In some embodiments, nanostructured materials (e.g., nanofibers) are pure ceramic nanostructured materials (e.g., nanofibers), nanostructured materials (e.g., nanofibers) comprising ceramic, or nanostructured materials (e.g., nanofibers) substantially comprised or consisting essentially of ceramic. In some embodiments, the nanostructured materials comprising ceramic component (e.g., ceramic nanofiber) comprises about 99.99%, about 99.95%, about 99.9%, about 99%, about 98%, about 97%, about 96%, about 95%, about 90%, about 80%, and the like of ceramic by mass. In some embodiments, the nanostructured materials comprising ceramic component (e.g., ceramic nanofiber) comprises at least about 99.99%, at least about 99.95%, at least about 99.9%, at least about 99%, at least about 98%, at least about 97%, at least about 96%, at least about 95%, at least about 90%, at least about 80%, at least about 50%, at least about 30% and the like of ceramic by mass.

In some embodiments, the ceramic is a metal oxide, including oxides of any metal previously listed as being suitable for a metal nanofiber. Exemplary ceramics include but are not limited to Al₂O₃, ZrO₂, Fe₂O₃, CuO, NiO, ZnO, CdO, SiO₂, TiO₂, V₂O₅, VO₂, Fe₃O₄, SnO, SnO₂, CoO, CoO₂, Co₃O₄, HfO₂, BaTiO₃, SrTiO₃, and BaSrTiO₃. In certain embodiments, ceramic containing materials (e.g., nanofibers) provided herein are optionally produced by use of a sol gel precursor in the fluid stock or one or more metal precursor in the fluid stock with calcination under oxidizing conditions in the thermal treatment step.

In specific embodiments, nanostructure materials provided herein comprise a metal component, wherein the metal component is a metal alloy. In various embodiments, the metal alloy includes any metal or combination of metals. In some instances, the alloy is an alloy between a metal and a non-metal, such as carbon. In specific embodiments, a metal alloy provided herein comprises: transition metal, alkali metal, alkaline earth metal, post-transition metal, lanthanide, actinide, or metalloid (e.g., germanium (Ge), antimony (Sb), polonium (Po), or silicon (Si)). Exemplary metal alloys include, but are not limited to CdSe, CdTe, PbSe, PbTe, FeNi (perm alloy), Fe—Pt intermetallic compound, Pt—Pb, Pt—Pd, Pt—Bi, Pd—Cu, and Pd—Hf. Methods for producing metal alloy nanofibers are disclosed herein and may include electrospinning a fluid stock comprising a mixture of the metal precursor(s) of the metal(s) found in the alloy. In some instances, for zero oxidation alloys, thermal treatment (e.g., calcination of the metal precursor(s) to metal alloy) occurs under reducing conditions. For example, a CdSe alloy nanofiber is optionally produced by electrospinning a fluid stock comprising a mixture of cadmium acetate and selenium acetate (as well as the block co-polymer discussed herein), followed by calcinating under reducing conditions.

Provided in various embodiments herein are metal-ceramic hybrid (i.e., nanocomposite) nanofibers, nanofibers comprising metal-ceramic hybrid, or nanofibers substantially comprised of metal-ceramic hybrid. In some embodiments, the metal-ceramic hybrid is any suitable metal-ceramic hybrid, including the hybrids of the metals described as being suitable for a metal nanofiber including: transition metal, alkali metal, alkaline earth metal, post-transition metal, lanthanide, actinide, or metalloied (e.g., germanium (Ge), antimony (Sb) or polonium (Po)). In some instances, the ceramic is a metal oxide described herein.

In other embodiments, a nanostructured material (e.g., nanofiber) described herein comprise a metal component, wherein the metal component is a metal carbide. Optional metals are as described herein. In some instances, exemplary metal-carbides include, but are not limited to, TiC, SiC, and WC. Methods for producing metal-ceramic hybrid nanofibers are disclosed herein and may include electrospinning a fluid stock comprising a mixture of the pure metal and ceramic precursors and calcinating under reducing conditions. For example, in some instances, a SiC containing nanofiber is produced by electrospinning a fluid stock consisting of a mixture of silicon acetates and PAN, followed by calcinating under reducing conditions. Further experimental for the preparation of carbide is described in co-pending application U.S. Provisional Patent Application Ser. No. 61/701,903, filed Sep. 17, 2012, entitled “Carbonaceous Metal/Ceramic Nanofibers,” and which is incorporated herein by reference for such disclosure.

In some embodiments, nanostructured materials (e.g., nanofibers), such as metal component (e.g., metal or metal oxide) or ceramic containing materials, provided herein comprise less than 10% carbon by mass (e.g., elemental mass). In specific embodiments, such materials comprise less than 7% carbon by mass. In more specific embodiments, such materials comprise less than 5% carbon by mass. In more specific embodiments, such materials comprise less than 3% carbon by mass. In still more specific embodiments, such materials comprise less than 1% carbon by mass. In some embodiments, nanostructured materials, such as metal component containing materials (e.g., metal-single metal, mixed metal, or metal alloys), provided herein comprise less than 5% oxygen by mass (e.g., elemental mass). In certain embodiments, such materials comprise less than 3% oxygen by mass. In specific embodiments, such materials comprise less than 2% oxygen by mass. In more specific embodiments, such materials comprise less than 2% oxygen by mass. In still more specific embodiments, such materials comprise less than 0.5% oxygen by mass.

In addition to metal, metal oxide, ceramic, or alloy nanofibers, a nanostructured material (e.g., nanofiber) that may be included in or derived from a precursor included in the fluid stock, including other ceramic or metal component materials. For example, in some embodiments, the ceramic component is a calcium phosphate (CaPO₄) nanofiber. The methods of the present disclosure may produce high quality porous calcium phosphate containing nanofibers.

In some embodiments, the methods of the present disclosure are combined with other methods to produce yet more embodiments of the present disclosure. For example, the nanofiber is surface-modified. For example, enzymes are immobilized on the nanofiber surface to create a biological catalyst. In another example, doping processes from the semiconductor industry is employed to intentionally introduce impurities into an extremely pure semiconductor nanofiber for the purpose of modulating its electrical properties.

Other components are optionally included in the nanostructured material (e.g., nanofiber(s)). In some embodiments, the nanostructured materials (e.g., porous, particularly ordered porous, nanofibers) comprise nanoparticles. In some embodiments, the nanoparticles are added to a fluid stock (e.g., the fluid stock comprising a block co-polymer described herein) from which an as-prepared (first) material (e.g., as-spun nanofiber) is produced. In some embodiments, the inclusion of nanoparticles has an influence on the geometry of the pores as formed herein. FIG. 2 shows the predicted confined assembly of a model symmetric block co-polymer with increasing concentrations of nanoparticles (dark internal elements) from left to right (10% left, 20% center, and 30%) right. The plots below show the radial concentration profiles of each block and nanoparticle. In some embodiments, a continuous matrix described herein comprises less than half of the mass of the nanofiber, but forms the continuous matrix that runs along the length of the nanofiber. In some instances, the continuous matrix runs along at least 50% the length of the nanofiber (e.g., on average for populations of nanofibers). In specific instances, the continuous matrix runs along at least 70% the length (e.g., on average) of the nanofiber(s). In more specific instances, the continuous matrix runs along at least 80% the length (e.g., on average) of the nanofiber(s). In still more specific embodiments, the continuous matrix runs along at least 90% of the length (e.g., on average) of the nanofiber(s). In yet more specific embodiments, the continuous matrix runs along at least 95% of the length (e.g., on average) of the nanofiber(s).

### Process for Making Porous Nanofibers

Described herein are methods for producing porous (e.g., mesoporous) nanostructured materials (e.g., porous, particularly ordered porous, nanofibers). The method comprises producing a first material (e.g., nanofiber) that comprises at least two components (e.g., at least two blocks of a block co-polymer), optionally treating the first (as-prepared) material (e.g., as-spun nanofiber) to order the two components within or on the material (e.g., nanofiber) (e.g., annealing the material/nanofiber), and selectively removing at least one of the components from the material (e.g., nanofiber) (e.g., one of the blocks of a block co-polymer or the organic materials, such as polymeric materials and residual organics from metal precursors) to produce a nanostructured material (e.g., porous nanofiber, such as with ordered pores).

In some embodiments, the components comprise a major component and a minor component. In some embodiments, the as-prepared material (e.g., as-spun nanofiber) comprises more of the major component than the minor component by mass. In certain embodiments, e.g., in the case of block co-polymers, the major component comprises more repeat units than the minor component. In various embodiments, the ratio of the amount of major component to the amount of minor component is varied, resulting in pores of different controlled size, shape and distribution. In some embodiments, the major component at least partially surrounds the minor component. In some embodiments, the minor component at least partially surrounds the major component. In some embodiments, the major component and minor component are arranged in any suitable geometry in or on the nanofiber. Exemplary major and minor components include the blocks of a block co-polymer as described herein. In addition to varying the amounts of the various components, the sizes of the various blocks of the block co-polymer are also varied in some embodiments, resulting in pores of different controlled size, shape and distribution.

In certain embodiments, e.g., upon preparation of a material (e.g., spinning of the material) or upon annealing of a material, the major and minor components of a (pre-treatment) material provided herein comprises cubic-type structures, hexagonal-type structures, reverse hexagonal-type structures, lamellar-type structures, helical-type structures, assembled micelle-type structures, gyroid-type structures, spherical structures, cylindrical structures, layered structures, channel structures, bicontinuous structures, or the like. In certain instances, e.g., wherein the fluid stock comprises a sol gel precursor system, the annealing step is absent and the major and minor components (e.g., of a block co-polymer) form micelle structures. In other embodiments, e.g., wherein the fluid stock comprises a metal precursor that is not a part of a sol gel precursor system, the annealing steam is utilized and a structure described above is achieved.

In some instances, the major and minor components (e.g., blocks of a block co-polymer) have the capability of self-organizing. However, in certain instances, they will be initially disorganized when first prepared (e.g., nanofibers emerging from the electrospinner). In some embodiments, the major and minor components self-organize into a more ordered configuration, self-organize into ordered phase elements or re-organize into different phase elements in the as-prepared material (e.g., as-spun nanofiber). In some embodiments, an annealing step results in ordering or re-ordering of the phase elements. In some instances, annealing provides sufficient energy to overcome an activation energy for phase transition from a less ordered state to a more ordered state, from an unordered state to an ordered state, or from a first ordered state to a second ordered state. In some embodiments, ordering is by like-component to like-component (e.g., hydrophobic blocks of a block co-polymer assembling into a hydrophobic phase element). The left-most 4 panels of FIG. 3 show an increasing degree of annealing from left to right (images a) to d)). The top row show TEM images of microtomed cross sections of a nanofiber, while the bottom row show the corresponding images of sections parallel to the fiber axis. The length of the scale bars is 200 nm.

In some embodiments, the as-prepared material (e.g., as-spun nanofiber) is coated prior to annealing (e.g., concurrent with preparation or subsequent to preparation). In some embodiments, the coating allows the as-prepared material (e.g., as-spun nanofiber) to retain its morphology (e.g., a cylinder) or prevents other adverse effects (e.g., swelling of the material/nanofiber). In some embodiments, the coating is applied by co-axial electrospinning as described herein. Other methods suitable for applying the coating include dipping, spraying, electro-deposition for example. Following annealing, the coating is optionally removed. The right-most images in FIG. 3 show a pure PS-b-PI co-polymer fiber after removal of a thermally stable silica coating by etching with NaOH.

In some embodiments, one or more of the components and/or ordered phase elements are selectively removed from the ordered materials (e.g., nanofiber(s)), e.g., following annealing, to produce ordered pores. Methods suitable for selectively removing material from the ordered materials (e.g., nanofiber(s)) are described herein.

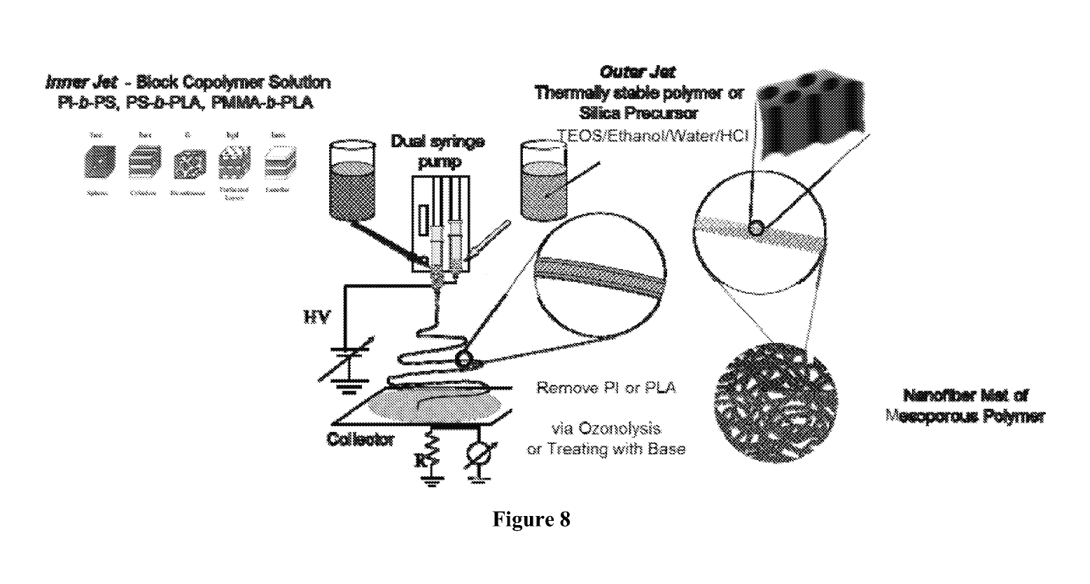

FIG. 8 illustrates certain processes described herein for producing mesoporous nanofibers (e.g., mesoporous polymeric nanofibers). In some embodiments, a fluid stock comprising a block co-polymer (e.g., PI-b-PS, PS-b-PLA, PMMA-b-PLA, or other copolymer described herein) is electrospun. In specific embodiments, the fluid stock is coaxially electrospun with a second fluid stock, the second fluid stock comprising a coating agent (or coating agent precursor), such as a carrier polymer or a ceramic sol gel precursor system. In some instances, an inner jet of a block co-polymer is formed from the fluid stock, with an outer jet formed from the second fluid stock, is prepared as a result of the coaxial electrospinning Nanofibers are generally collected on a collector. Collected nanofibers are optionally annealed to order the block co-polymer (e.g., as spheres, cylinders, perforated layers, lamellae). In some instances, one block (e.g., the PI or PLA block) is removed (e.g., via ozonolysis or treating with a base). In further or additional instances, the outer layer of the nanofiber is also removed (by the same or different process of removing the one block). In some embodiments, such a process is utilized to yield mesoporous polymeric nanofibers.

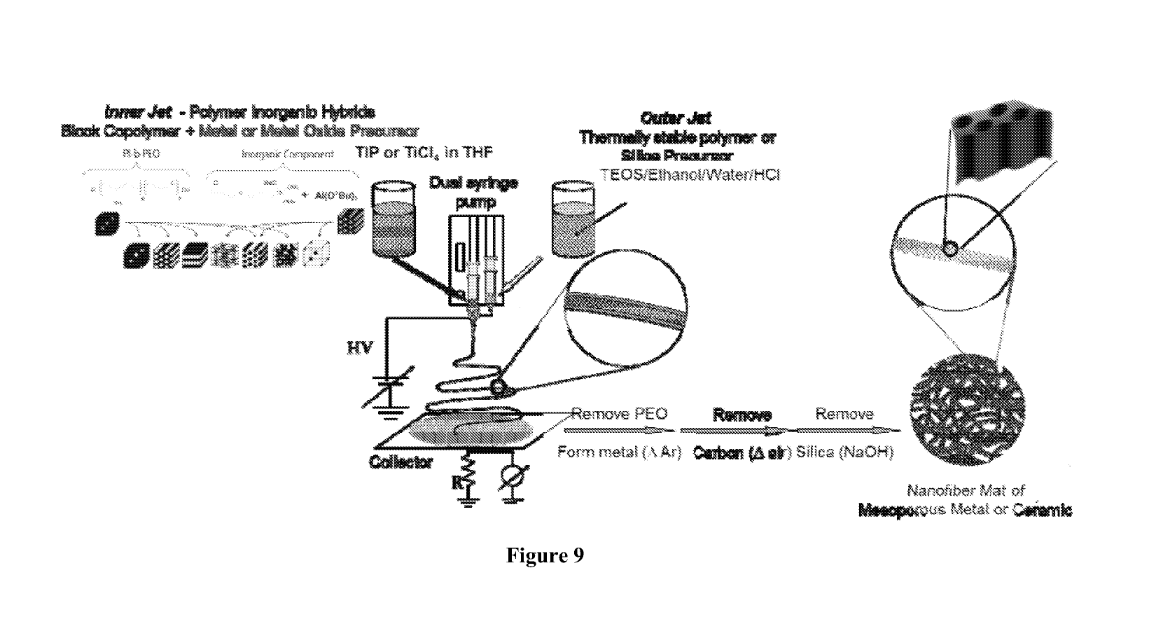

FIG. 9 illustrates other embodiments for producting mesoporous nanofibers described herein (e.g., mesoporous metal, metal oxide or ceramic nanofibers). In some embodiments, the fluid stock used to produce an inner jet comprises a block co-polymer solution (e.g., PI-b-PEO) and an inorganic component (e.g., a metal precursor described herein). In specific embodiments, e.g., to stablize the electrospun inner jet, the fluid stock is electrospun with a second fluid stock to produce an outer jet. In specific embodiments, the second fluid stock comprises a coating agent, such as a carrier polymer (e.g., a thermally stable polymer) or silica sol gel precursor system. In some embodiments, electrospinning of the nanofibers is gas-assisted (e.g., coaxially gas assisted). Nanofibers are generally collected on a collector. Collected nanofibers are optionally annealed to order the block co-polymer (e.g., as spheres, cylinders, perforated layers, lamellae). In some embodiments, the resultant nanofiber is thermally treated. In specific instances, thermal treatment results in the removal of all or some of the block copolymer, all or some of the coat layer, and calcines the metal precusor to a metal component (e.g., metal oxide, metal, or ceramic). In some instances, this process results in a mesoporous nanofiber comprising a continuous (mesoporous) matrix of a metal component (e.g., metal, metal oxide, or ceramic). In certain embodiments, the thermal treatment is performed under inert conditions, resulting in the formation of a metal. In other embodiments, thermal treatment is performed concurrent with chemical treatment and results in the formation of a metal oxide or ceramic. In some embodiments, a thermal/inert treatment is performed followed by a thermal/oxidation (e.g., air) treatment. In some embodiments, the outer layer is removed in a separate process (e.g., if the outer layer is silica, it is optionally removed by etching in NaOH).

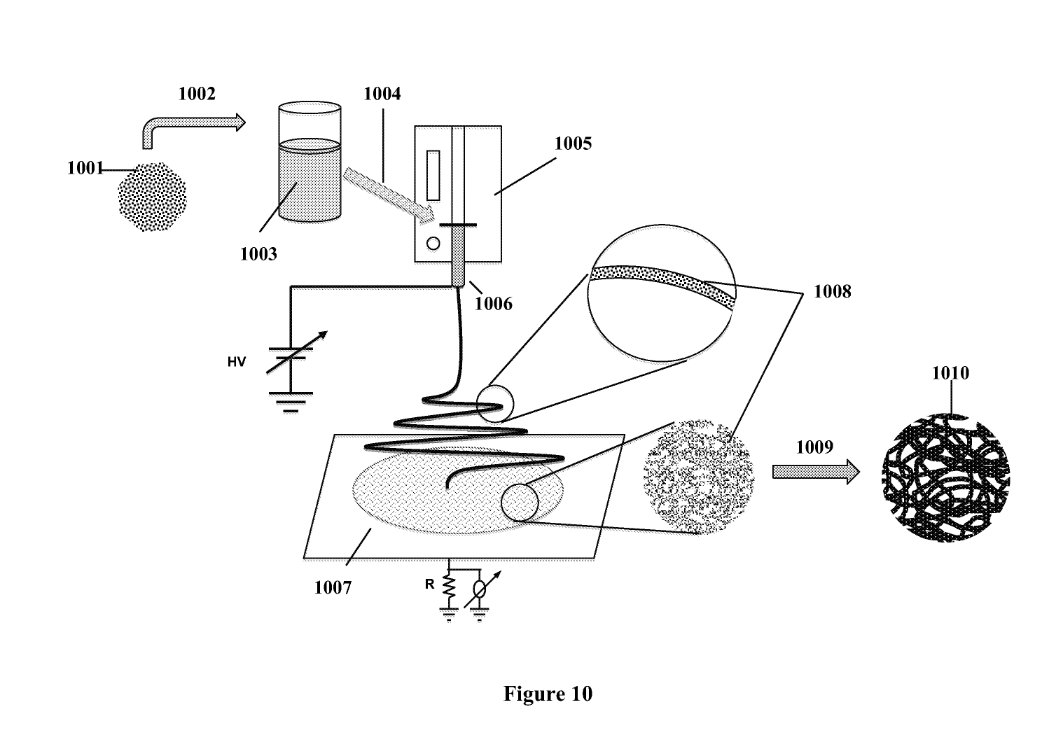

FIG. 10 illustrates certain embodiments for producing mesoporous nanofibers described herein (e.g., mesoporous carbon nanofibers). In some embodiments, block co-polymer 1001 is used to prepared (e.g., with a fluid, such as water, alcohol, or solvent) to prepare 1002 a fluid stock 1003. The fluid stock is provided 1004 to an electrospinning apparatus (e.g., using a syringe 1005). In some instances the fluid stock is electrospun via a needle (e.g., a coaxial needle) 1006, with optional gas assistance (e.g., coaxial gas assistance). In some instances, an inner jet of a the fluid stock is electrospun with an outer jet of air (e.g., coaxial gas assistance). Nanofibers 1008 are generally collected on a collector 1007. Collected nanofibers are optionally annealed to order the block co-polymer (e.g., as spheres, cylinders, perforated layers, lamellae). In some instances, thermal (and/or chemical) treatment 1009 yields mesoporous nanofibers 1010 (e.g., mesporous carbon nanofibers if no metal precursor is utilized).

### Methods for Electrospinning

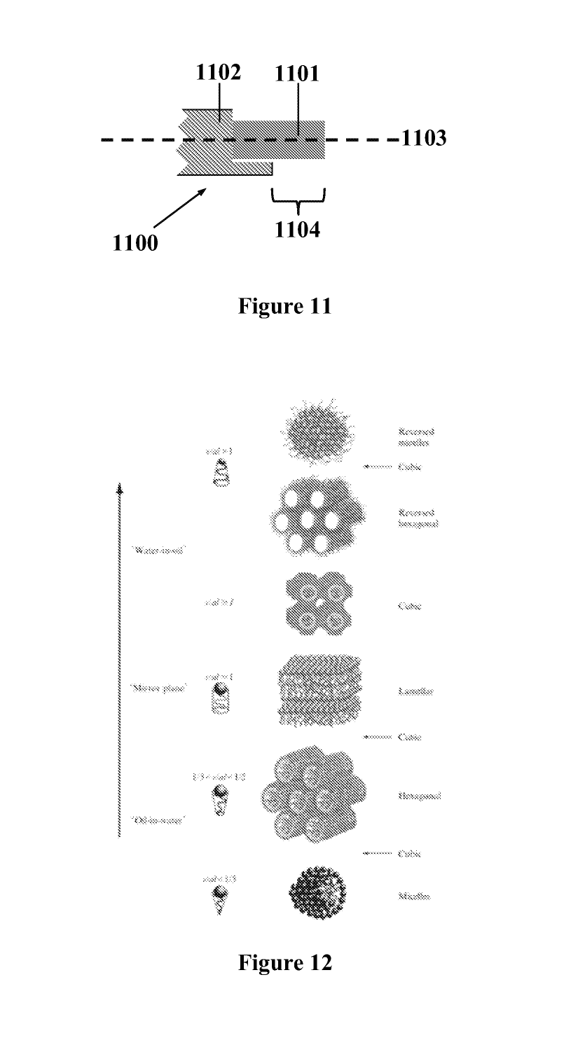

In one aspect, described herein is a method for producing a nanostructured material (e.g., porous nanofiber(s), in particular ordered porous nanofiber(s)) that comprises electrospinning a fluid stock that comprises at least two components (e.g., two blocks of a block co-polymer). In some instances, such components form ordered phase elements, and at least one of which is removable as described herein. Any suitable method for electrospinning is used. In some embodiments, polymer melt or polymer solution (aqueous, alcohol, DMF, or other solvent based solution) electrospinning is optionally utilized. In specific embodiments, aqueous solution electrospinning is utilized. In other specific embodiments, alcohol solution electrospinning is utilized. In certain embodiments, co-axial electrospinning is utilized. In general, co-axial electrospinning is to be understood to include electrospinning of at least two fluids about a common axis. In some instances, two, three, or four fluids are electrospun about a common axis. In some embodiments, at least one of the co-axially spun fluids is a gas (thereby rendering the electrospinning gas assisted). In some instances, a common axis is an axis that is substantially similar to the axis through which a first fluid is electrospun, e.g., within 5 degrees, within 3 degrees or within 1 degree of the first fluid. FIG. 11 illustrates co-axial electrospinning apparatus 1100. The coaxial needle apparatus comprises an inner needle 1101 and an outer needle 1102, both of which needles are coaxially aligned around a similar axis 1103. In some embodiments, further coaxial needles may be optionally placed around, inside, or between the needles 1101 and 1102, which are aligned around the axis 1103. In some instances, the termination of the needles is optionally offset 1104.

Any suitable electrospinning technique is optionally utilized. For example, elevated temperature electrospinning is described in U.S. Pat. No. 7,326,043 filed on Oct. 18, 2004; U.S. patent application Ser. No. 13/036,441 filed on Feb. 28, 2011; and U.S. Pat. No. 7,901,610 filed on Jan. 10, 2008, which are incorporated herein for such disclosure. In some embodiments, the electro-spinning is gas-assisted as described in PCT Patent Application PCT/US11/24894 filed on Feb. 15, 2011, which is incorporated herein for such disclosure. Briefly, gas-assisted electrospinning comprises expelling a stream of gas at high velocity along with the fluid stock (e.g., as a stream inside the fluid stock or surrounding the fluid stock). In some instances, gas-assisted electrospinning, increases the through-put of an electrospinning process, the morphology of a resultant nanofiber, or the like.

In some embodiments, the method comprises co-axially electrospinning a first fluid stock with a second fluid stock to produce a first nanofiber. Exemplary co-axial electrospinning techniques are described in PCT Patent Application PCT/US11/24894 filed on Feb. 15, 2011, which is incorporated herein for such disclosure. In some embodiments, the first fluid stock comprises at least one block co-polymer, the second fluid stock comprises a coating agent, and the first nanofiber comprises a first layer (e.g., a core) and a second layer (e.g., a coat) that at least partially coats the first layer. In addition, a gas is optionally co-axially electrospun with the first and second fluid stocks.

### Fluid Stocks

In various embodiments, various processes are utilized to prepare a first (as prepared) material from a fluid stock described herein. In some aspects the methods described herein comprise electrospinning a fluid stock. In other instances, fluid stocks described herein are optionally cast, spin coated, or the like to prepare a first material which may then be converted to a nanostructured material according to the processes described herein. In some embodiments, electrospinning of the electrospun fluid stock produces a nanofiber.

In some embodiments, the fluid stocks are solvent-based (e.g., comprise an organic solvent such as hexane) or aqueous (i.e., water-based or containing). In specific embodiments, fluid stocks suitable for producing metal, ceramic, metal alloy, or any combination thereof (e.g., hybrid/composite nanofibers) comprise a water soluble polymer and precursor molecules. In specific instances, such combinations are distributed substantially uniformly on a block of the polymer (e.g., via an association, such as a condensation reaction, between the precursor and a monomeric residue). Such association are more thoroughly described in International Patent Application PCT/US 12/53097, filed Aug. 30, 2012, U.S. patent application Ser. No. 13/451,960, filed Apr. 20, 2012, and published as US 2012/0282484 on Nov. 8, 2012, and U.S. Provisional Patent Publication No. 61/528,895 filed on Aug. 30, 2011, which are incorporated herein for such disclosure and the disclosure of various metal precursors.

In specific embodiments, the fluid stock comprises a block co-polymer. In more specific embodiments, the fluid stock comprises a block co-polymer and a precursor. In still more specific embodiments, the fluid stock comprises a block co-polymer and a metal precursor. In yet more specific embodiments, the fluid stock comprises an amphiphilic block co-polymer and a metal precursor. In some embodiments, the fluid stock comprises a block co-polymer and a sol gel system (e.g., as prepared by the combination of TEOS, ethanol and HCl(aq)). In specific embodiments, the fluid stock comprises or is prepared by the combination of (i) at least one block co-polymer, (ii) a sol-gel precursor (e.g., TEOS), (iii) alcohol or water, and (iv) an optional acid (e.g., aqueous HCl).

In some embodiments, precursors include materials that are optionally converted to another material upon treatment of the as-spun or annealed material. For example, in some instances, the precursor is a metal precursor (which may be converted to a metal, a metal oxide, a ceramic, or the like), ceramic (sol gel) precursor, carbon precursor, or any combination thereof in various embodiments. In some embodiments, a carbon precursor is a polymer (e.g., polyacrylonitrile or other carrier polymer described herein), wherein thermal treatment of the electrospun fluid stock is capable of converting the carbon precursor into a continuous carbon matrix (e.g., a carbon nanofiber).

In some embodiments, fluid stocks described herein optionally comprise nanoparticles (e.g., of any suitable shape). In some embodiments, such nanoparticles comprise metal component nanoparticles, metal nanoparticles (e.g., single metal or metal alloy), metal oxide nanoparticles, ceramic nanoparticles, nanoclay nanoparticles, or the like. In some instances, such metal components, metals, metal oxides, ceramics, etc. are optionally any such metal components, metals, metal oxides, ceramics, etc. described for the nanostructured materials (e.g., porous nanofibers) or precursors described herein. Moreover, nanoclays as described in U.S. Pat. No. 7,083,854 filed on May 10, 2005, are optionally utilized. Components of fluid stocks, as described in U.S. patent application Ser. No. 11/694,435 filed on Mar. 30, 2007 or PCT Patent Application No. PCT/US10/35220 filed on May 18, 2010, are optionally utilized in the fluid stocks herein, which references are incorporated herein for such disclosure.

In some embodiments, e.g., wherein a metal, metal oxide, or ceramic containing nanostructure material is desired, a fluid stock described herein comprises a metal precursor. In specific embodiments, the fluid stock comprises at least two metal precursors (e.g., in instances where a alloy, mixture, or hybrid/composite is desired). In certain embodiments, the metal precursor is a metal-ligand association (complex) (e.g., a coordination complex), each metal precursor comprising metal atom(s) associated (complexed) with one or more ligand(s) (e.g., 1-10, 2-9, or any suitable number of ligands). In specific embodiments, the precursor described herein comprises at least two different types of ligand (e.g., at least one acetate and at least one halide). In some embodiments, the precursor is a metal carboxylate (e.g., —OCOCH₃ or another —OCOR group, wherein R is an alkyl, substituted alkyl, aryl, substituted aryl, or the like). In specific embodiments, the precursor is lithium acetate, beryllium acetate, sodium acetate, magnesium acetate, aluminum acetate, silicon acetate, potassium acetate, calcium acetate, titanium acetate, vanadium acetate, chromium acetate, manganese acetate, iron acetate, cobalt acetate nickel acetate, copper acetate, zinc acetate, gallium acetate, germanium acetate, zirconium acetate, palladium acetate, silver acetate, cadmium acetate, tin acetate, barium acetate, hafnium acetate, tungsten acetate, lead acetate, or the like. In certain embodiments, the precursor is a metal nitrate. In specific embodiments, the precursor is lithium nitrate, beryllium nitrate, sodium nitrate, magnesium nitrate, aluminum nitrate, silicon nitrate, potassium nitrate, calcium nitrate, titanium nitrate, vanadium nitrate, chromium nitrate, manganese nitrate, iron nitrate, cobalt nitrate nickel nitrate, copper nitrate, zinc nitrate, gallium nitrate, germanium nitrate, zirconium nitrate, palladium nitrate, silver nitrate, cadmium nitrate, tin nitrate, barium nitrate, hafnium nitrate, tungsten nitrate, lead nitrate, or the like. In some embodiments, the precursor is a metal alkoxide (e.g., a methoxide, ethoxide, isopropyl oxide, t-butyl oxide, or the like). In specific embodiments, the precursor is lithium alkoxide, beryllium alkoxide, sodium alkoxide, magnesium alkoxide, aluminum alkoxide, silicon alkoxide, potassium alkoxide, calcium alkoxide, titanium alkoxide, vanadium alkoxide, chromium alkoxide, manganese alkoxide, iron alkoxide, cobalt alkoxide nickel alkoxide, copper alkoxide, zinc alkoxide, gallium alkoxide, germanium alkoxide, zirconium alkoxide, palladium alkoxide, silver alkoxide, cadmium alkoxide, tin alkoxide, barium alkoxide, hafnium alkoxide, tungsten alkoxide, lead alkoxide, or the like. In some embodiments, the precursor is a metal halide (e.g., chloride, bromide, or the like). In specific embodiments, the precursor is lithium halide, beryllium halide, sodium halide, magnesium halide, aluminum halide, silicon halide, potassium halide, calcium halide, titanium halide, vanadium halide, chromium halide, manganese halide, iron halide, cobalt halide nickel halide, copper halide, zinc halide, gallium halide, germanium halide, zirconium halide, palladium halide, silver halide, cadmium halide, tin halide, barium halide, hafnium halide, tungsten halide, or the like. In certain embodiments, the precursor is a diketone (e.g., acetylacetone, hexafluoroacetylacetone, or the like). In specific embodiments, the precursor is lithium diketone, beryllium diketone, sodium diketone, magnesium diketone, aluminum diketone, silicon diketone, potassium diketone, calcium diketone, titanium diketone, vanadium diketone, chromium diketone, manganese diketone, iron diketone, cobalt diketone nickel diketone, copper diketone, zinc diketone, gallium diketone, germanium diketone, zirconium diketone, palladium diketone, silver diketone, cadmium diketone, tin diketone, barium diketone, hafnium diketone, tungsten diketone, lead diketone, or the like.

In certain embodiments, a fluid stock described herein comprises a sol gel precursor, such as tetraethyl orthosilicate (TEOS), calcium nitrate tetrahydrate, sodium silicate, aluminum nitrate nonahydrate, aluminum hydroxide, or the like. In certain embodiments, the fluid stock comprises a sol gel system, which is prepared by combining a sol gel precursor with the requisite agents to initiate the sol gel reaction. For example, in some embodiments, a sol gel system comprises a reaction mixture formed from the combination of TEOS, ethanol, and HCl.

In some embodiments, the precursor is only or preferentially soluble in one of the components of the fluid stock (e.g., is preferentially soluble in one of the polymer blocks of a block co-polymer over another of the polymer blocks—which, in some instances, results in a much higher concentration of the precursor in a phase element formed by the self-assembly of one block (e.g., a hydrophilic or hydrophobic block) of a block co-polymer, than in a phase element formed by the self assembly of another block (e.g., a hydrophobic or hydrophilic portion) of the block co-polymer in an as-prepared/as-spun or annealed nanostructured material/nanofiber). In some embodiments, calcination of the nanofiber converts the precursor to nanofiber material only in certain portions of the nanofiber (i.e., where the precursor is soluble and therefore located).

Any fluid stock, or combination of fluid stocks that form ordered phase elements and are capable of forming ordered pores by selectively removing at least part of a phase element are suitable.

### Block Co-Polymers

In some embodiments, the fluid stock comprises a polymer. In some embodiments, the polymer is a co-polymer (i.e., is a polymer derived from two or more monomeric species, as opposed to a homopolymer where only one monomer is used). In specific embodiments, co-polymers provided herein comprise incompatible monomer/monomeric residue species (i.e., immiscible in each other). In other specific embodiments, co-polymers provided herein comprise monomer/monomeric residue species that microphase separate to form periodic nanostructures (i.e., phase elements) within a material (e.g., nanofiber). In certain instances, microphase separation provided herein results because the incompatible monomers are covalently bound to each other in the co-polymer and therefore cannot macroscopically de-mix. In contrast to macroscopic de-mixing, the monomeric residues of certain block co-polymer provided herein form small structures (i.e., phase elements).

In some embodiments, the co-polymer is a graft co-polymer. Graft co-polymers are a type of branched co-polymer where the side chains are structurally distinct from the main chain. The main chain can be a homo-polymer or a co-polymer. The side chain(s) can be homo-polymer(s) or co-polymer(s). Any arrangement of main chain(s) and side chain(s) may be suitable for forming ordered phase elements and/or nanofibers having ordered pores.

Another suitable type of co-polymer is a “block co-polymer”. Block co-polymers are made up of blocks of different polymerized monomers. For example, PS-b-PMMA is short for polystyrene-block-poly(methyl methacrylate). And is optionally made by first polymerizing styrene, and then subsequently polymerizing MMA from the reactive end of the polystyrene chains. This polymer is a “diblock co-polymer” because it contains two different chemical blocks. Triblocks, tetrablocks, multiblocks, etc. are also suitable. In some embodiments, diblock co-polymers are made using living polymerization techniques, such as atom transfer free radical polymerization (ATRP), reversible addition fragmentation chain transfer (RAPT), ring-opening metathesis polymerization (ROMP), and living cationic or living anionic polymerizations for example. Another suitable technique is chain shuttling polymerization. Another strategy for preparing block co-polymers is the chemoselective stepwise coupling between polymeric precursors and heterofunctional linking agents. This method may be used to produce more complex structures such as tetrablock quarterpolymers for example. Any suitable method for producing block co-polymers may be used to produce the ordered porous nanofibers described herein.

In some embodiments, the block co-polymer comprises at least two types of monomeric species designated “A” and “B”. In some embodiments, the blocks of the block co-polymer have a particular size (e.g., number of polymerized “A” monomers per block of “A” and/or number of polymerized “B” monomers per block of “B”). In various embodiments, the “A” block and/or “B” block have a distribution of sizes, or are monodisperse (e.g., all “A” blocks have 20 polymerized “A” monomers within a suitably low standard deviation (e.g., 5%, 10%, 20% or 50%)).

In some embodiments, the block co-polymer comprises 3 types of monomeric species designated “A”, “B” and “C”. For example, in some embodiments, the PI and PLA blocks of a PS-b-PI-b-PLA tri-block co-polymer are removed, resulting in a nanofiber that is about 70% porous. Greater numbers of monomeric species are optionally used to incorporate various materials (i.e., hybrid nanofibers) and/or create more complex structures.

Depending on the relative size of each block, several morphologies are obtained. In diblock copolymers, sufficiently different block lengths lead to nanometer-sized spheres of one block in a matrix of the second (for example PMMA in polystyrene). Using less different block lengths, a “hexagonally packed cylinder” geometry is obtained. In some embodiments, blocks of similar length form layers (i.e., lamellar phase). In some embodiments, a gyroid phase forms at block lengths intermediate between the cylindrical and lamellar phase. The sizes of the blocks of the block co-polymer are variable in any suitable manner to form phase elements and/or nanofiber pores having a desired geometry. In some embodiments, the block co-polymer is amphiphilic (e.g., has at least one hydrophobic block and at least one hydrophilic block).

In various embodiments, any suitable co-polymer (e.g., block co-polymer) is utilized. In some embodiments, a suitable co-polymer is an amphiphilic co-polymer. In certain embodiments, a suitable co-polymer is a co-polymer that is a surfactant. In certain embodiments, the co-polymer is a di-block co-polymer comprising a first and second block, the first and second blocks being different from one another. In other embodiments, the co-polymer is a tri-block co-polymer, comprising a first, second, and third block, wherein at least two of the blocks are different from one another. In specific embodiments, each block has a minimum of at least 10 monomeric residues. In more specific embodiments, each block has a minimum of at least 20 monomeric residues, or at least 30 monomeric residues.

In some embodiments, the co-polymer is a block copolymer having a structure of formula (I): -(A_{d}R¹ₙ—BR²ₘ)ₐ—(WₑRₒ—XR⁴ₚ)_{b}—(Y_{f}R⁵_{q}—ZR⁶ᵣ)_{c}—. In some embodiments, each of A, B, W, X, Y, and Z are independently selected from C, O, N, or S. In certain embodiments, at least one of A or B is C, at least one of W or X is C, and at least one of Y and Z is C. In some embodiments, each and each of R¹, R², R³, R⁴, R⁵, and R⁶ are independently selected from H, halo, CN, OH, NO₂, NH₂, NH(alkyl) or N(alkyl)(alkyl), SO₂alkyl, CO₂-alkyl, alkyl, heteroalkyl, alkoxy, S-alkyl, cycloalkyl, heterocycle, aryl, or heteroaryl. In certain embodiments, the alkyl, alkoxy, S-alkyl, cycloalkyl, heterocycle, aryl, or heteroaryl is substituted or unsubstituted. In some embodiments, any alkyl described herein is a lower alkyl, such as a C₁-C₆ or C₁-C₃ alkyl. In certain embodiments, each R1, R3, and R5 is the same or different. In specific embodiments, at least one of R1, R3, and R5 is not H. In some embodiments, at least one R1 is not H, at least one R3 is not H, and/or at least one R5 is not H. In certain embodiments, -(AR¹ₙ—BR²ₘ)ₐ— and —(WR³ₒ—XR⁴ₚ)_{b}— are different. In some embodiments, a is 1-1000, b is 1-1000 and c is 0-1000. In specific embodiments, a is 10-200, b is 10-200 and c is 0-200. In more specific embodiments, a is 10-200, b is 10-200 and c is 10-200. In alternative embodiments, a is 10-200, b is 10-200 and c is 0. In certain embodiments, each of n, m, o, p, q, and r are 0-3, e.g., depending on the nature of the A, B, W, X, Y, and Z, respectively. In some embodiments, each of d, e, and f is independently 1-12. In more specific embodiments, each of d, e, and f is independently 1-6, or, more specifically, 1-2. In specific embodiments, a substituted group is optionally substituted with one or more of H, halo, CN, OH, NO₂, NH₂, NH(alkyl) or N(alkyl)(alkyl), SO₂alkyl, CO₂-alkyl, alkyl, heteroalkyl, alkoxy, S-alkyl, cycloalkyl, heterocycle, aryl, or heteroaryl. In certain embodiments, the block co-polymer is terminated with any suitable residue, e.g., H, OH, or the like.

In some embodiments, a suitable block co-polymer is a block copolymer comprising a first block and a second block, the first and second blocks having an affinity for themselves and/or an aversion to each other (or an insolubility in each other). In some embodiments, a suitable block co-polymer comprises a first block and a second block, wherein the first block is hydrophilic and the second block is hydrophobic or lipophilic (including, e.g., wherein the first block is more hydrophilic than the second block, or the second block is more hydrophobic than the first block). In some embodiments, the block-copolymer comprises at least one block comprising (e.g., on monomeric residues thereof) alcohol groups, ether groups, amine groups, or combinations thereof (or other nucleophilic groups).

For example, in certain embodiments, the block co-polymer comprises a polyvinyl alcohol (PVA) block, a polyethylene oxide (PEO) block, polyvinylpyridine block or any combination thereof. In certain embodiments, block co-polymers provided herein comprise (e.g., as a hydrophobic or lipophilic block) a polyimide block, a polylactic acid (PLA) block, a polypropylene oxide (PPO) block, polystyrene (PS) block, a nylon block, a polyacrylate block (e.g., poly acrylic acid, polyalkylalkacrylate—such as polymethylmethacrylate (PMMA), polyalkylacrylate, polyalkacrylate), polyacrylamide (PAA) block, polyvinylpyrrolidone (PVP) block, polyacrylonitrile (PAN), or any combination thereof. In some embodiments, the block co-polymer comprises a thermally or chemically degradable polymer block, e.g., a polyisoprene (PI) block, a polylactic acid (PLA) block, a polyvinyl alcohol (PVA) block, a polyethylene oxide (PEO) block, a polyvinylpyrrolidone (PVP) block, polyacrylamide (PAA) block or any combination thereof. In certain embodiments, the block co-polymer comprises thermally or chemically stable polymer block, e.g., a polystyrene (PS) block, a poly(methyl methacrylate) (PMMA) block, a polyacrylonitrile (PAN) block, or any combination thereof. In certain embodiments, the block co-polymer comprises a block degradable under chemical or thermal conditions, and a second block that is not degradable under such conditions.

In specific embodiments, a block co-polymer described herein is or comprises PI-b-PEO, PAN-b-PEO, PVA-b-PS, PEO-b-PPO-b-PEO, PPO-b-PEO-b-PPO, PVA-b-PEO, PVA-b-PAN, PVA-b-PPO, PI-b-PS, PEO-b-PS, PI-b-PS, PVA-PMMA, PVA-PAA, PEO-b-PMMA, or a combination thereof. In more specific embodiments, the block co-polymer comprises PI-b-PS, PS-b-PLA, PMMA-b-PLA, PI-b-PEO, PAN-b-PEO, PVA-b-PS, PEO-b-PPO-b-PEO, PPO-b-PEO-b-PPO, or any combination thereof.

The block co-polymer has any suitable assembly domain length (length of units of monomer A in the polymer for example; Lₒ). FIG. 4 shows predicted mesopore morphologies (shown in gray) in asymmetric block co-polymer nanofibers at three different ratios of fiber diameter (D) to assembly domain length (Lₒ) from course-grained molecular dynamics simulations. As seen, this D/L, ratio results in different pore morphologies at a constant ratio of block “A” to block “B” (e.g., 2:8).

In one aspect, a method of preparing nanostructured materials described herein comprises selectively removing at least part of the block co-polymer from the nanofiber (e.g., thereby producing an ordered mesoporous nanofiber). In some embodiments, selectively removing at least part of the block co-polymer comprises selectively degrading and/or removing one block of the block co-polymer. In some embodiments, the block co-polymer comprises a degradable block and/or a removable block. For example, the degradable block may be chemically degradable, thermally degradable, or any combination thereof. Examples of thermally or chemically degradable blocks include polyimide (PI), polylactic acid (PLA), polyvinyl alcohol (PVA), polyethylene oxide (PEO), polyvinylpyrrolidone (PVP), and polyacrylamide (PAA).

In some embodiments, the block co-polymer further comprises a block that does not degrade under conditions suitable for degrading and/or removing the degradable and/or removable block. In some embodiments, the block co-polymer comprises a thermally stable block and/or a chemically stable block. Examples of thermally or chemically stable blocks include polystyrene (PS), poly(methyl methacrylate) (PMMA), and polyacrylonitrile (PAN).

Exemplary block co-polymers suitable for use in the methods described herein comprise PI-b-PS, PS-b-PLA, PMMA-b-PLA, PI-b-PEO, PAN-b-PEO, PVA-b-PS, PEO-b-PPO-PEO, PPO-b-PEO-PPO, or any combination thereof. The notation “-b-” indicates that the polymer is a block co-polymer comprising the indicated blocks before and after the “-b-”.

### Nanofiber Coatings

In some embodiments, a method for producing a nanostructured material (e.g., a porous nanofiber, such as an ordered porous nanofiber)=described comprises coating a first nanofiber, wherein the first nanofiber comprises a co-polymer (e.g., block co-polymer). As described in certain embodiments herein, the blocks of the block co-polymer microphase separate to create ordered structures. In some embodiments, the time required for microphase separation is reduced by annealing the first nanofiber as described herein. In some embodiments, the coating protects the first nanofiber and/or helps to maintain the morphology of the first nanofiber (e.g., size and shape of the nanofiber) under annealing conditions (e.g., increased temperature or contact with chemicals). In some embodiments, the coating allows the timescale for microphase separation of the block co-polymer to match the timescale for electrospinning the first fluid stock into a first nanofiber. The coating has any suitable thickness.

The coating and/or coating agent (i.e., material that comprises the coating) comprises any suitable material. In some embodiments the coating is thermostable. In some embodiments, the coating agent comprises silica, a thermostable polymer (e.g., PS, PMMA or PAN), or any combination thereof. In some embodiments, the coating agent is dissolved in and/or combined with any other suitable material, such as in a fluid stock capable of being electrospun. In some embodiments, the coating at least partially surrounds the first nanofiber. In some embodiments, the first nanofiber is surrounded by the coating agent.

The coating is applied in any suitable manner. In some embodiments, the first nanofibers are immersed (e.g., dipped, dunked) in a coating agent. In some embodiments, the coating agent is sprayed onto the first nanofibers. In yet more embodiments, the coating agent is electrodeposited on the first nanofibers.

In some embodiments, the first fluid stock comprising the block co-polymer is co-axially electrospun with a second fluid stock, wherein the second fluid stock comprises a coating agent. Methods and devices for co-axial electrospinning are described in PCT Patent Application PCT/US11/24894 filed on Feb. 15, 2011. The second fluid stock surrounds the first fluid stock in some embodiments.

### Annealing of Nanofibers

In some embodiments, a method for producing an ordered porous nanofiber is described wherein the method comprises annealing a nanofiber. In some embodiments, the nanofiber comprises a minor component and major component capable of microphase separation (e.g., a block co-polymer). In some embodiments, the annealing step facilitates self-assembly of the block co-polymer into ordered phase elements as described herein.

The ordered phase elements have any suitable size or shape, as described herein. Non-limiting examples are spheres, cylinders, layers, channels, or any combination thereof.

In some embodiments, the nanofiber is heated at conditions sufficient to allow the block co-polymers to form ordered phase elements. The heating is at any suitable temperature for any suitable amount of time. For example, the nanofiber is heated to a temperature of about 40° C., about 50° C., about 60° C., about 80° C., about 100° C., about 200° C., and the like. In some embodiments, the nanofiber is heated to a temperature of at least 40° C., at least 50° C., at least 60° C., at least 80° C., at least 100° C., at least 200° C., and the like. In some embodiments, the nanofiber is maintained at an elevated temperature (i.e., heated) for about 1 minute, about 5 minutes, about 20 minutes, about 60 minutes, and the like. In some embodiments, the nanofiber is maintained at an elevated temperature (i.e., heated) for at least 1 minute, at least 5 minutes, at least 20 minutes, at least 60 minutes, and the like.

In some embodiments, the nanofiber is contacted with a chemical (i.e., chemically annealed) at conditions sufficient to allow the block co-polymers to form ordered phase elements. The nanofiber is contacted with any suitable chemical, including for example water or organic solvents such as hexane, acetone, ethanol, and the like. In some embodiments, the coating is not soluble in the chemical. In some embodiments, the chemical is diffusible through the coating.

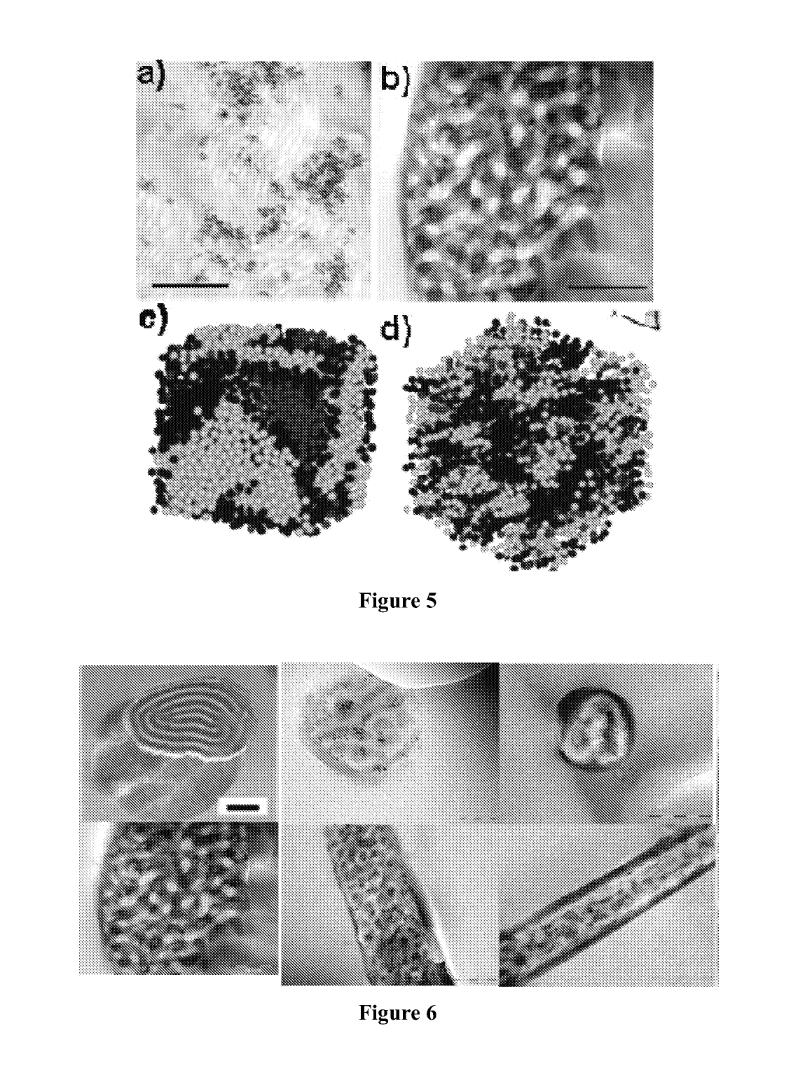

In some embodiments, external forces are be used in methods of annealing. For example, in some embodiments, magnetite nanoparticles are added to the fluid stock and/or nanoparticles and external magnetic fields are used to orient and/or position the magnetite nanoparticles. Another suitable external field is the force of elongation of the nanofiber as it is being electrospun. FIG. 5 shows TEM images of 1 wt % magnetite nanoparticles in PS-b-PI film (image a)) and 10 wt % magnetite nanoparticles in a PS-b-PI nanofiber (image b)). Images c) and d) are snapshots of coarse grained molecular dynamics (CGMD) simulation of block co-polymer nanoparticles systems with no flow and an elongation rate of 0.2, demonstrating that the nanoparticles dispersion is at least partially controlled by elongational flow.

FIG. 6 shows TEM images of block co-polymer PS-b-PI nanofibers with and without magnetite nanoparticles.

### Optional Removal of Nanofiber Coatings

In some embodiments, the second layer (i.e., coating) is optionally removed from the first nanofiber to produce a second nanofiber. The coating is optionally removed following annealing, wherein the second nanofiber comprises a block co-polymer ordered into phase elements.

The coating is removed by any suitable method. In some embodiments, the coating is removed by heat. In some embodiments, the heat required for removing the coating is greater than the heat required for annealing the nanofiber. The heating is at any suitable temperature for any suitable amount of time. For example, the second nanofiber is heated to a temperature of about 40° C., about 50° C., about 60° C., about 80° C., about 100° C., about 200° C., and the like. In some embodiments, the second nanofiber is heated to a temperature of at least 40° C., at least 50° C., at least 60° C., at least 80° C., at least 100° C., at least 200° C., and the like. In some embodiments, the second nanofiber is maintained at an elevated temperature (i.e., heated) for about 1 minute, about 5 minutes, about 20 minutes, about 60 minutes, and the like. In some embodiments, the second nanofiber is maintained at an elevated temperature (i.e., heated) for at least 1 minute, at least 5 minutes, at least 20 minutes, at least 60 minutes, and the like.

In some embodiments, the coating is removed by ozonolysis (e.g., contacting with ozone). Ozonolysis is performed in any suitable manner for any suitable amount of time. In some embodiments, the coating is removed by treating with water (e.g., when the coating is water-soluble). In some embodiments, the coating is removed by treating with acid (e.g., hydrochloric acid, acetic acid, sulfuric acid, etc. . . . ). The acid is at any suitable concentration. In some embodiments, the coating is removed by treating with a base (e.g., sodium hydroxide). In some embodiments, the coating is removed by “combined soft and hard” (CASH) chemistries.

### Selective Removal of Nanofiber Materials

In one aspect, nanofibers are described wherein at least part of the nanofiber is removed, resulting in an ordered porous nanofiber. In another aspect, methods for making ordered porous nanofibers are described wherein the method comprises removing at least part of the nanofiber. In some embodiments, the removed portion of the nanofiber is at least part of the block co-polymer. The portion of the block co-polymer that is removed is at least one of the ordered phase elements and/or at least one of the blocks of the block co-polymer in some embodiments, generally the degradable and/or removable block. In some embodiments, the removal of at least part of the nanofiber is selective (i.e., removes the degradable and/or removable block, but not the block that does not degrade under conditions suitable for degrading and/or removing the degradable and/or removable block).

The portion of the block co-polymer is removed by any suitable method. In some embodiments, the portion of the block co-polymer is removed by heat. In some embodiments, the heat required for removing the portion of the block co-polymer is greater than the heat required for annealing the nanofiber. The heating is at any suitable temperature for any suitable amount of time. For example, the nanofiber is heated to a temperature of about 40° C., about 50° C., about 60° C., about 80° C., about 100° C., about 200° C., and the like. In some embodiments, the nanofiber is heated to a temperature of at least 40° C., at least 50° C., at least 60° C., at least 80° C., at least 100° C., at least 200° C., and the like. In some embodiments, the nanofiber is maintained at an elevated temperature (i.e., heated) for about 1 minute, about 5 minutes, about 20 minutes, about 60 minutes, and the like. In some embodiments, the nanofiber is maintained at an elevated temperature (i.e., heated) for at least 1 minute, at least 5 minutes, at least 20 minutes, at least 60 minutes, and the like.

In some embodiments, the portion of the block co-polymer is removed by ozonolysis (e.g., contacting with ozone). Ozonolysis is performed in any suitable manner for any suitable amount of time. In some embodiments, the portion of the block co-polymer is removed by treating with water (e.g., when the coating is water-soluble). In some embodiments, the portion of the block co-polymer is removed by treating with acid (e.g., hydrochloric acid, acetic acid, sulfuric acid, etc. . . . ). The acid is at any suitable concentration. In some embodiments, the portion of the block co-polymer is removed by treating with a base (e.g., sodium hydroxide). In some embodiments, the portion of the block co-polymer is removed by “combined soft and hard” (CASH) chemistries.

In some embodiments, the portion of the block co-polymer is removed at the same time, or with the same conditions as are capable of removing the optional coating. In some embodiments, the optional coating is removed before removal of the portion of the block co-polymer. In some embodiments, the optional coating is removed after removal of the portion of the block co-polymer. In some embodiments, the conditions used to remove the optional coating are different from the conditions used to remove the portion of the block co-polymer. In various embodiments, the portion of the block co-polymer is removed before annealing (i.e., from the first nanofiber) or after annealing (i.e., from the second nanofiber). In various embodiments, the portion of the block co-polymer is removed before conversion of the electrospun fluid stock to a nanofiber (i.e., calcination) or after calcination.

### CASH Chemistries

In some embodiments, at least part of the block co-polymer and/or at least part of the optional coating are removed using “combined soft and hard” (CASH) chemistries. In some embodiments, described herein are ordered porous nanofibers in which at least part of the block co-polymer and/or at least part of the optional coating have been removed using “combined soft and hard” (CASH) chemistries.

In one embodiment, CASH involves selective, sequential removal of more than one block of the block co-polymer after conversion of precursor molecules (e.g., metal or ceramic precursors as described in U.S. Provisional Patent Application 61/528,895 filed on Aug. 30, 2011) to a nanofiber. For example, when TiO₂ precursors are associated with the PEO block of PI-b-PEO, heating under inert gas removes the PEO block (e.g., forming mesopores) and converts the PI (minor) block to an amorphous (soft) carbon shell at the mesopore walls. Subsequent heating under air removes the carbon near the mesopore walls, while forming crystalline (hard) TiO₂.

In one aspect, removal by CASH chemistries comprises selective removal of the degradable block and/or removable block followed by selective removal of the block that does not degrade under conditions suitable for degrading and/or removing the degradable and/or removable block.

In one aspect, removal by CASH chemistries comprises degrading and/or removing the first block of a block co-polymer comprising a first block and a second block, wherein at least part of the second block converts to amorphous (i.e., soft) carbon and degrading and/or removing the amorphous carbon (e.g., thereby removing the first block and the second block of the block co-polymer).

As described herein, the first block of a block co-polymer is degraded and/or removed (i.e., as part of a CASH chemistry step or procedure) using any suitable technique. In some embodiments, the degrading and/or removing the first block of the block co-polymer comprises heating under inert gas.

The amorphous carbon is optionally degraded and/or removed. The amorphous carbon is degraded and/or removed using any suitable technique. In some embodiments, degrading and/or removing the amorphous carbon comprises heating under air.

In some embodiments, the ordered porous nanofibers and methods for producing ordered porous nanofibers described herein comprise producing a nanofiber comprising a major component and a minor component, annealing the nanofiber as described herein, selectively removing at least part of the minor component from the nanofiber (e.g. thereby producing an ordered mesoporous nanofiber), and optionally removing at least part of the major component from the nanofiber. In some embodiments, the minor component is degradable and/or removable. In some embodiments, the major component is not degraded and/or removed at conditions suitable for degrading and/or removing the minor component. In some embodiments, the major component is degradable and/or removable (or degraded and/or removed) following selectively removing at least part of the minor component from the nanofiber.

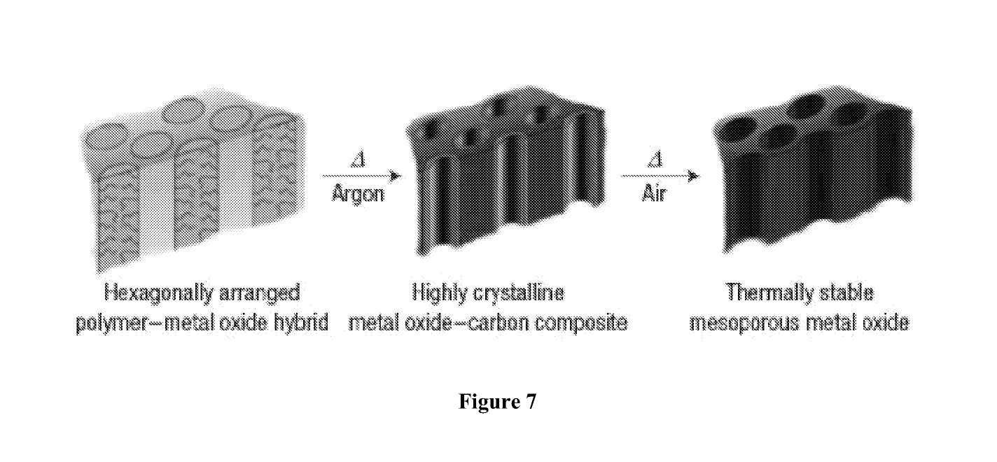

The CASH chemistries method is illustrated in FIG. 7, for example. Here, in-situ formed carbon acts as a rigid support enabling the synthesis of highly crystalline nanoporous transition metal oxides with uniform pores. An initial heating in argon removes one component and converts the polymer material near the pore walls to amorphous (soft) material, which is removed in a subsequent heating in air.

### Exemplary Compositions, Systems and Applications of Ordered Porous Nanofibers

In one aspect, encompassed within the scope of the present invention are the ordered porous nanofibers produced by any of the methods described herein. In some embodiments, the nanofibers produced as described herein are collected (i.e., into a composition comprising a plurality of the nanofibers described herein).

In some embodiments the nanofiber composition has a high surface area. In some embodiments, ordering of the pores results in the collection of nanofibers having a high surface area and/or specific surface area (e.g., surface area per mass of nanofiber and/or surface area per volume of nanofiber). The surface area and/or specific surface area is any suitable value. In some embodiments, the collection of porous nanofibers have a specific surface area of about 10 m²/g, about 50 m²/g, about 100 m²/g, about 200 m²/g, about 500 m²/g, about 1,000 m²/g, about 2,000 m²/g, about 5,000 m²/g, about 10,000 m²/g, and the like. In some embodiments, the collection of porous nanofibers have a specific surface area of at least 10 m²/g, at least 50 m²/g, at least 100 m²/g, at least 200 m²/g, at least 500 m²/g, at least 1,000 m²/g, at least 2,000 m²/g, at least 5,000 m²/g, at least 10,000 m²/g, and the like.

In one aspect, described herein is a system suitable for producing ordered mesoporous nanofibers. The system comprises a fluid stock comprising block co-polymer, wherein the fluid stock optionally comprises metal and/or ceramic precursor. The system also comprises an electrospinner, a nanofiber collection module and a heater. The system optionally also comprises a second fluid stock comprising a coating agent. In some embodiments, the electrospinner is configured to be gas-assisted (e.g., as described in PCT Patent Application PCT/US11/24894 filed on Feb. 15, 2011). In some embodiments, the various components of the system interact (or are capable of interacting) to produce ordered porous nanofibers. For example, the fluid stock comprising the block co-polymer and metal and/or ceramic precursor is co-axially electrospun with a second fluid stock comprising a coating agent. In this example, the productivity of the system is increased by also emanating a stream of gas with the fluid stock(s) from the electrospinner (i.e., gas assisted). The heater is capable of annealing the electrospun fluid stock(s), from which components are removed (e.g., the coating and a degradable block of the block co-polymer) to create an ordered porous nanofiber.

The ordered porous nanofibers (and/or compositions including nanofibers) described herein are incorporated or capable of being incorporated into any suitable device, product, process, and the like. For example, the present invention encompasses a battery, capacitor, electrode, solar cell, catalyst, adsorber, filter, membrane, sensor, fabric, and/or tissue regeneration matrix comprising the nanofibers described herein. Also included are methods for making a battery, capacitor, electrode, solar cell, catalyst, adsorber, filter, membrane, sensor, fabric, and/or tissue regeneration matrix comprising the ordered porous nanofibers described herein. For example, the ordered porous nanofibers described herein can be incorporated into the filter cartridges as described in U.S. Provisional Patent Application 61/538,458 filed on Sep. 23, 2011.

### CERTAIN DEFINITIONS

The articles “a”, “an” and “the” are non-limiting. For example, “the method” includes the broadest definition of the meaning of the phrase, which can be more than one method. In the disclosure, references to “a” material includes disclosure of a plurality of such materials. In addition, where a characteristic is referred to for “a” material, the present disclosure includes a disclosure to a plurality of such materials (e.g., nanofibers) having an average of the recited characteristic.

The term “alkyl” as used herein, alone or in combination, refers to an optionally substituted straight-chain, or optionally substituted branched-chain saturated or unsaturated hydrocarbon radical. Examples include, but are not limited to methyl, ethyl, n-propyl, isopropyl, 2-methyl-1-propyl, 2-methyl-2-propyl, 2-methyl-1-butyl, 3-methyl-1-butyl, 2-methyl-3-butyl, 2,2-dimethyl-1-propyl, 2-methyl-1-pentyl, 3-methyl-1-pentyl, 4-methyl-1-pentyl, 2-methyl-2-pentyl, 3-methyl-2-pentyl, 4-methyl-2-pentyl, 2,2-dimethyl-1-butyl, 3,3-dimethyl-1-butyl, 2-ethyl-1-butyl, n-butyl, isobutyl, sec-butyl, t-butyl, n-pentyl, isopentyl, neopentyl, tert-amyl and hexyl, and longer alkyl groups, such as heptyl, octyl and the like. Whenever it appears herein, a numerical range such as “C₁-C₆ alkyl,” means that: in some embodiments, the alkyl group consists of 1 carbon atom; in some embodiments, 2 carbon atoms; in some embodiments, 3 carbon atoms; in some embodiments, 4 carbon atoms; in some embodiments, 5 carbon atoms; in some embodiments, 6 carbon atoms. The present definition also covers the occurrence of the term “alkyl” where no numerical range is designated. In certain instances, “alkyl” groups described herein include linear and branched alkyl groups, saturated and unsaturated alkyl groups, and cyclic and acyclic alkyl groups.

The term “aryl” as used herein, alone or in combination, refers to an optionally substituted aromatic hydrocarbon radical of six to about twenty ring carbon atoms, and includes fused and non-fused aryl rings. A fused aryl ring radical contains from two to four fused rings, where the ring of attachment is an aryl ring, and the other individual rings are alicyclic, heterocyclic, aromatic, heteroaromatic or any combination thereof. Further, the term aryl includes fused and non-fused rings containing from six to about twelve ring carbon atoms, as well as those containing from six to about ten ring carbon atoms. A non-limiting example of a single ring aryl group includes phenyl; a fused ring aryl group includes naphthyl, phenanthrenyl, anthracenyl, azulenyl; and a non-fused bi-aryl group includes biphenyl.

The term “heteroaryl” as used herein, alone or in combination, refers to optionally substituted aromatic monoradicals containing from about five to about twenty skeletal ring atoms, where one or more of the ring atoms is a heteroatom independently selected from among oxygen, nitrogen, sulfur, phosphorous, silicon, selenium and tin but not limited to these atoms and with the proviso that the ring of the group does not contain two adjacent O or S atoms. Where two or more heteroatoms are present in the ring, in some embodiments, the two or more heteroatoms are the same as each another; in some embodiments, some or all of the two or more heteroatoms are be different from the others. The term heteroaryl includes optionally substituted fused and non-fused heteroaryl radicals having at least one heteroatom. The term heteroaryl also includes fused and non-fused heteroaryls having from five to about twelve skeletal ring atoms, as well as those having from five to about ten skeletal ring atoms. In some embodiments, bonding to a heteroaryl group is via a carbon atom; in some embodiments, via a heteroatom. Thus, as a non-limiting example, an imidiazole group is attached to a parent molecule via any of its carbon atoms (imidazol-2-yl, imidazol-4-yl or imidazol-5-yl), or its nitrogen atoms (imidazol-1-yl or imidazol-3-yl). Further, in some embodiments, a heteroaryl group is substituted via any or all of its carbon atoms, and/or any or all of its heteroatoms. A fused heteroaryl radical contains from two to four fused rings, where the ring of attachment is a heteroaromatic ring. In some embodiments, the other individual rings are alicyclic, heterocyclic, aromatic, heteroaromatic or any combination thereof. A non-limiting example of a single ring heteroaryl group includes pyridyl; fused ring heteroaryl groups include benzimidazolyl, quinolinyl, acridinyl; and a non-fused bi-heteroaryl group includes bipyridinyl. Further examples of heteroaryls include, without limitation, furanyl, thienyl, oxazolyl, acridinyl, phenazinyl, benzimidazolyl, benzofuranyl, benzoxazolyl, benzothiazolyl, benzothiadiazolyl, benzothiophenyl, benzoxadiazolyl, benzotriazolyl, imidazolyl, indolyl, isoxazolyl, isoquinolinyl, indolizinyl, isothiazolyl, isoindolyloxadiazolyl, indazolyl, pyridyl, pyridazyl, pyrimidyl, pyrazinyl, pyrrolyl, pyrazinyl, pyrazolyl, purinyl, phthalazinyl, pteridinyl, quinolinyl, quinazolinyl, quinoxalinyl, triazolyl, tetrazolyl, thiazolyl, triazinyl, thiadiazolyl and the like, and their oxides, such as for example pyridyl-N-oxide.

The term “heteroalkyl” as used herein refers to optionally substituted alkyl structure, as described above, in which one or more of the skeletal chain carbon atoms (and any associated hydrogen atoms, as appropriate) are each independently replaced with a heteroatom (i.e. an atom other than carbon, such as though not limited to oxygen, nitrogen, sulfur, silicon, phosphorous, tin or combinations thereof), or heteroatomic group such as though not limited to —O—O—, —S—S—, —O—S—, —S—O—, ═N—N═, —N═N—, —N═N—NH—, —P(O)2-, —O—P(O)2-, —P(O)2-O—, —S(O)—, —S(O)2-, —SnH2- and the like.

The term “heterocyclyl” as used herein, alone or in combination, refers collectively to heteroalicyclyl groups. Herein, whenever the number of carbon atoms in a heterocycle is indicated (e.g., C1-C6 heterocycle), at least one non-carbon atom (the heteroatom) must be present in the ring. Designations such as “C1-C6 heterocycle” refer only to the number of carbon atoms in the ring and do not refer to the total number of atoms in the ring. Designations such as “4-6 membered heterocycle” refer to the total number of atoms that are contained in the ring (i.e., a four, five, or six membered ring, in which at least one atom is a carbon atom, at least one atom is a heteroatom and the remaining two to four atoms are either carbon atoms or heteroatoms). For heterocycles having two or more heteroatoms, in some embodiments, those two or more heteroatoms are the same; in some embodiments, they are different from one another. In some embodiments, heterocycles are substituted. Non-aromatic heterocyclic groups include groups having only three atoms in the ring, while aromatic heterocyclic groups must have at least five atoms in the ring. In some embodiments, bonding (i.e. attachment to a parent molecule or further substitution) to a heterocycle is via a heteroatom; in some embodiments, via a carbon atom.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

### EXAMPLES

### Example 1

### Preparation of Coated Polymer Nanofibers with Ordered Morphologies

Through methods described herein, a block co-polymer (PS-b-PDMAEMA) nanofiber with a ceramic poly(ureamethylvinyl)silazane (PUMVS) coat is prepared. The nanofiber is annealed until a nanofiber with helical morphology is achieved. FIG. 1 illustrates the nanofiber with helical morphology.

### Example 2

### Preparation of Polymer Nanofibers with Ordered Morphologies

Through methods described herein, a block co-polymer (PS-b-PI) nanofiber with silica coat is prepared. The left-most 4 panels of FIG. 3 show an increasing degree of annealing from left to right (images a) to d)). The top row show TEM images of microtomed cross sections of a nanofiber, while the bottom row show the corresponding images of sections parallel to the fiber axis. Following annealing, the coating is removed. The right-most images in FIG. 3 show a pure PS-b-PI co-polymer fiber after removal of a thermally stable silica coating by etching with NaOH. Following removal of the silica coating, the PI block is removed via ozonolysis to yield mesoporous polymeric nanofibers.

### Example 3

### Preparation of Polymer Nanofibers with Ordered Morphologies

Through methods described herein, a block co-polymer (PS-b-PI) film with and without 1 wt % or 10 wt % magnetite nanoparticles is prepared. FIG. 5 shows TEM images of 1 wt % magnetite nanoparticles that are aggregated in PS-b-PI film (image a)) and 10 wt % magnetite nanoparticles that are well dispersed in a PS-b-PI nanofiber (image b)). Images c) and d) are snapshots of coarse grained molecular dynamics (CGMD) simulation of block co-polymer nanoparticles systems with no flow and an elongation rate of 0.2, demonstrating that the nanoparticles dispersion is at least partially controlled by elongational flow. FIG. 5 illustrates one embodiment of TEM images (top) and coarse grained molecular dynamic simulations (bottom) for magnetite nanoparticles in PS-b-PI nanofiber. FIG. 6 shows TEM images of block co-polymer PS-b-PI nanofibers with and without magnetite nanoparticles.

### Example 4

### Preparation of Mesoporous Polymeric Nanofibers

As seen in FIG. 8, mesoporous polymeric nanofibers are produced as described herein. An inner jet of a block co-polymer solution (e.g., PI-b-PS, PS-b-PLA, PMMA-b-PLA) is electrospun with an outer jet of a thermally stable polymer or silica precursor. Nanofibers are collected on a collector. Collected nanofibers are annealed to order the block co-polymer (e.g., as spheres, cylinders, perforated layers, lamellae). The PI or PLA is removed via ozonolysis or treating with a base, for example, to yield mesoporous polymeric nanofibers.

### Example 5

### Preparation of Mesoporous Metallic and Ceramic Nanofibers

As seen in FIG. 9, mesoporous metallic and ceramic nanofibers are produced as described herein. An inner jet of a block co-polymer solution (e.g., PI-b-PEO) comprising an inorganic component is electrospun with an outer jet of a thermally stable polymer or silica precursor. Nanofibers are collected on a collector. Collected nanofibers are annealed to order the block co-polymer (e.g., as spheres, cylinders, perforated layers, lamellae). The PEO is removed and metal is formed by heating in argon. Carbon is removed by heating in air. Silica is removed by etching in NaOH to yield mesoporous metallic and ceramic nanofibers.

### Example 6

### Preparation of Mesoporous Carbon Nanofibers

As seen in FIG. 10, mesoporous carbon nanofibers are produced as described herein. An inner jet of a block co-polymer solution (e.g., PAN-b-PEO) is electrospun with an outer jet of air (i.e., gas assisted). Nanofibers are collected on a collector. Collected nanofibers are annealed to order the block co-polymer (e.g., as spheres, cylinders, perforated layers, lamellae). Thermal treatment yields mesoporous carbon nanofibers.

### Example 7

### Preparation of Mesoporous Silica Nanofibers from Coated Fibers

A shell stock of 0.3 g PVA and 2.7 g water are mixed and heated at 95 C for 8 hours. A core stock is prepared by mixing ethanol and Puronic F127 (poloxamer 407, a hydrophilic non-ionic surfactant and tri-block copolymer having the structure PEO₁₀₁-b-PPO₅₆-b-PEO₁₀₁) at room temperature for 8 hours. 1.5 g of TEOS is then added. And 0.26 g of water with 1 drop 12M HCl is added dropwise. The resultant combination is mixed at room temperature for 2 hours.

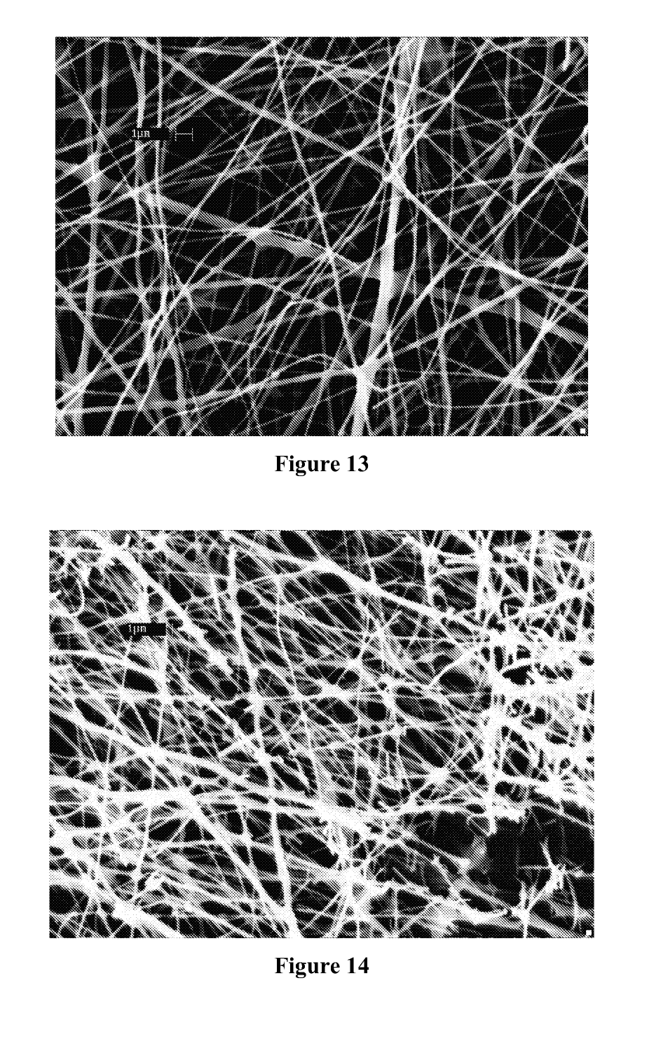

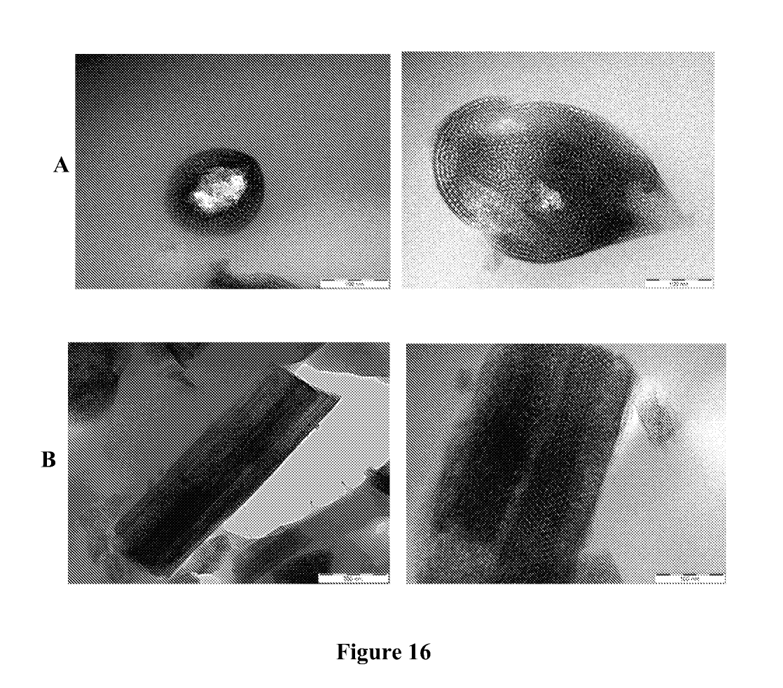

The two combinations are co-axially electrospun using a core flow rate of 0.005 mL/min and a shell flow rate of 0.015 mL/min, a voltage of 19 kV, and a tip to collector distance of 15 cm. FIG. 13 illustrates an SEM for the as-spun nanofiber having a shell layer of PVA and a core layer of a TEOS sol gel system combined with a PEO-PPO-PEO tri-block copolymer. These resultant nanofibers are annealed at 60 C for 12 hours in air, followed by 100 C for 6 hours in air. The annealed nanofibers are heated at 2 C/min to a temperature of 600 C for 2 hours, followed by cooling at 2 C/min. FIG. 14 illustrates an SEM of the resultant mesoporous silica. FIG. 15 illustrates microtomed nanofiber TEM images of such mesoporous silica nanofibers. FIG. 16 illustrates TEM images of cross-sectional (panel A) and longitudinal-sectional (panel B) of such fibers.

### Example 8

### Preparation of Mesoporous Silica Nanofibers from Fibers with No Coat

A stock is prepared by combining 5 g ethanol, 0.75 g TEOS, PVP, Pluronic (e.g., F127 or P123), and 0.1 g of 2 M HCl. The mixture is stirred for 0.5 minutes at 75 C.

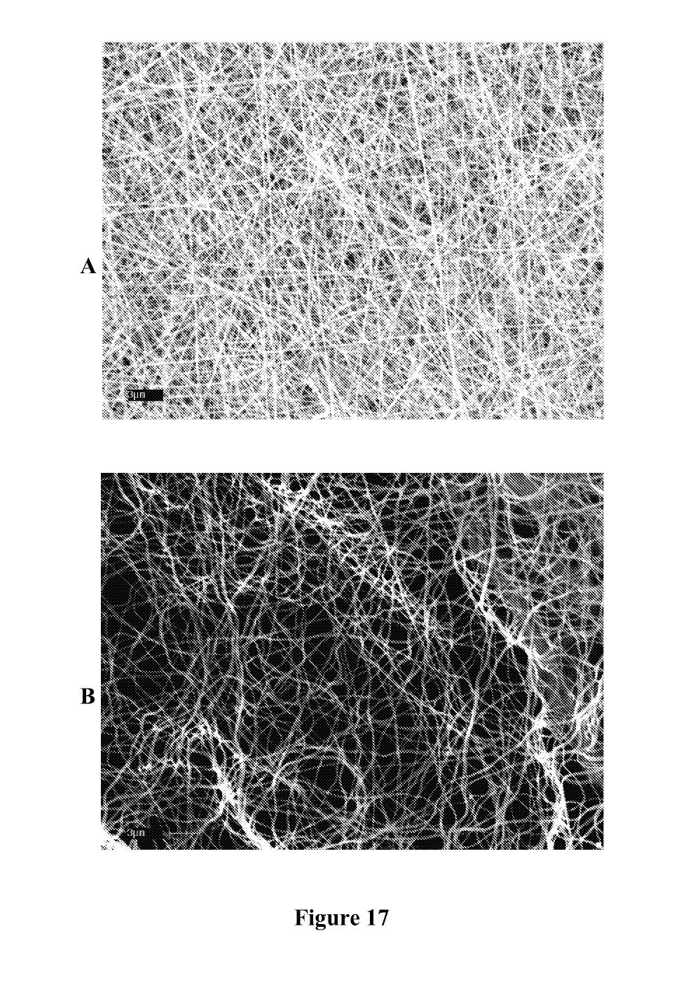

The fluid stock is electrospun using a flow rate of 0.015 mL/min, a voltage of 14 kV, and a tip to collector distance of 10 cm. The resultant nanofibers are thermally treated at 600 C for 2 hours, with a heating and cooling rate of 2 C/min FIG. 17 illustrates an SEM of the resultant mesoporous silica prepared from P123 (PEO₂₀-PPO₇₀-PEO₂₀) (panel A) and F127 (panel B). Table 1 illustrates additional parameters of such preparation:

TABLE 1

| Pluronic | Pluronic Conc. (wt %) | Fiber Diameter (nm) | Pore Formation |
|---|---|---|---|
| P123 | 24.0 | 156 +/− 26 | Rods |
| F127 | 19.5 | 204 +/− 45 | Spheres |

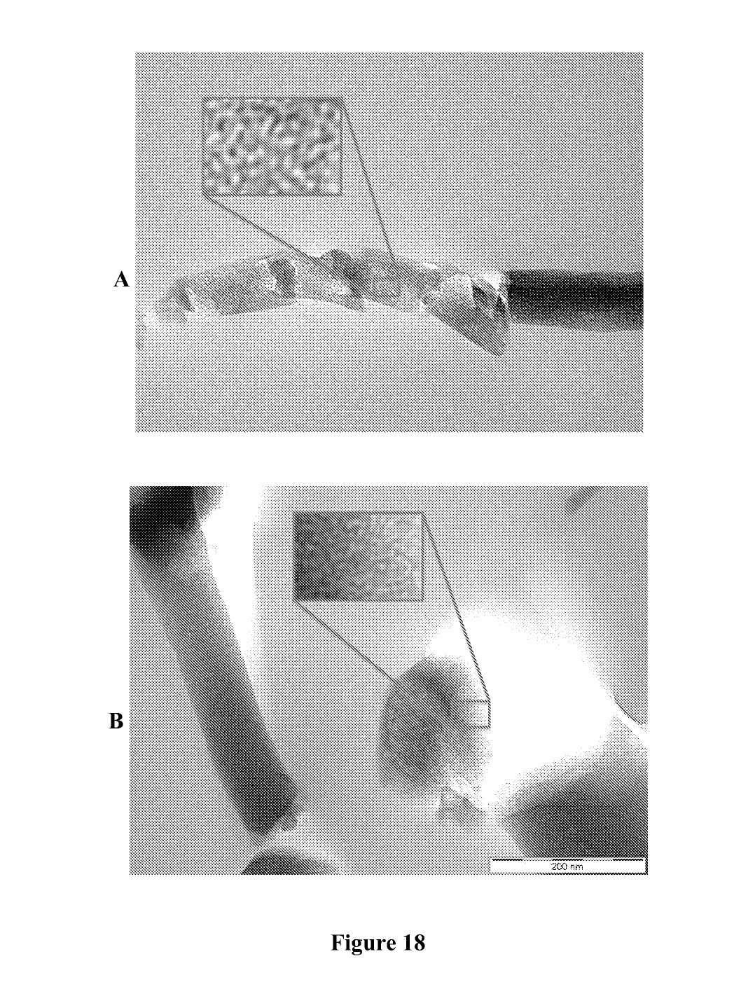

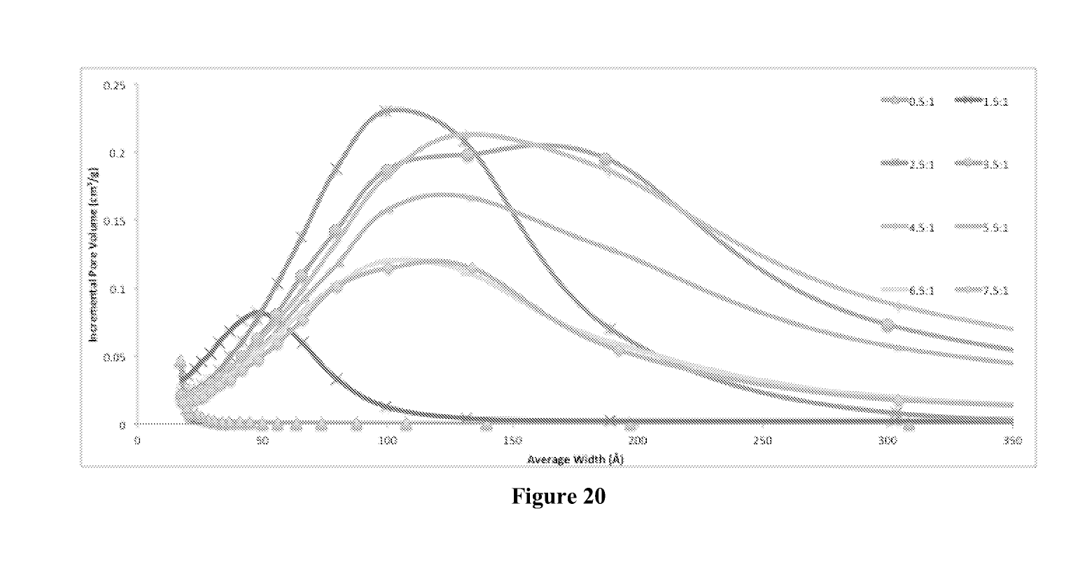

Similar procedure is used to prepare mesoporous films. FIG. 18 illustrates mesoporous silica films prepared from P123 (panel A) and F127 (panel B). Pore distributions for such mesoporous silica is illustrated in FIG. 19 for various block co-polymer concentrations Films are also prepared with a carrier polymer, but without co-polymers, providing materials with much greater pore distribution parameters. FIG. 20 illustrates pore distributions for such materials.

### Example 9

### Preparation of Mesoporous Nanostructured Materials from Non-Sol Gel System

Ethanol and metal precursor (e.g., metal acetate) are combined and stirred for 4 hours in cold water. Ethanol, PVP, and pluronic are combined and stirred for 4 hours at room temperature. The two combinations are mixed (with acetic acid) for 1 hour to prepare a stock.

The fluid stock is electropun using a flow rate of 0.015 mL/min, a voltage of 14 kV, and a tip to collector distance of 10 cm. The resultant nanofibers are optionally annealed, e.g., at a temperature of 50-100 C. The nanofibers are thermally treated at 650 C for 5 hours, with a heating and cooling rate of 2 C/min.

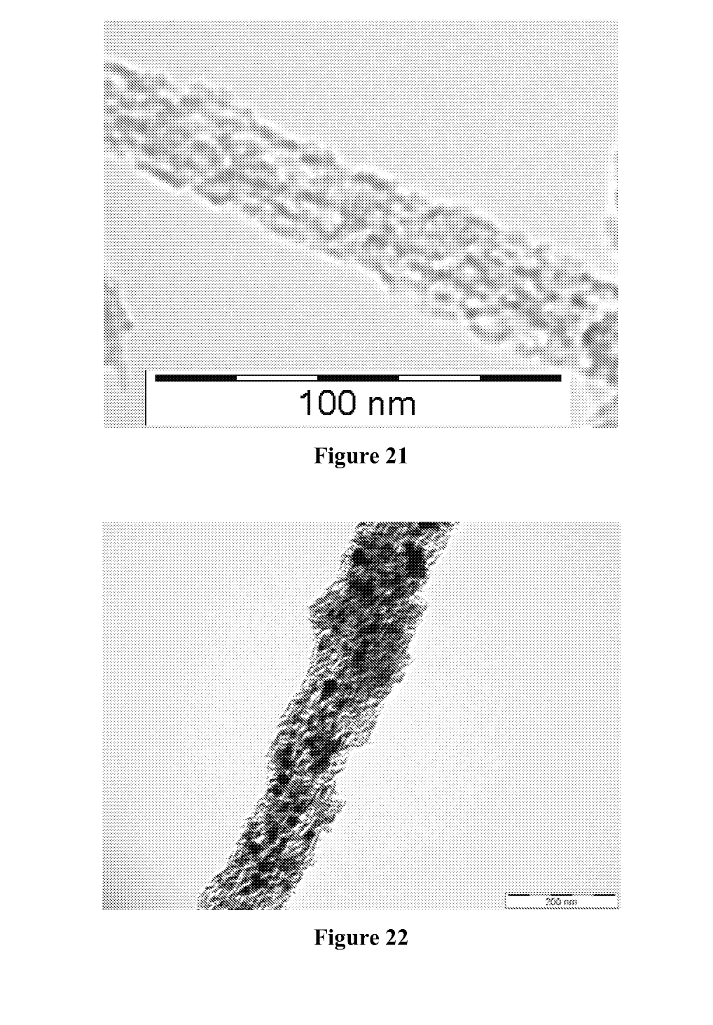

FIG. 21 illustrates alumina prepared from such a procedure, using aluminum acetate as the metal precursor. FIG. 22 illustrates alumnia with silver crystals prepared from such a procedure, using aluminum acetate and silver acetate as the metal precursors.

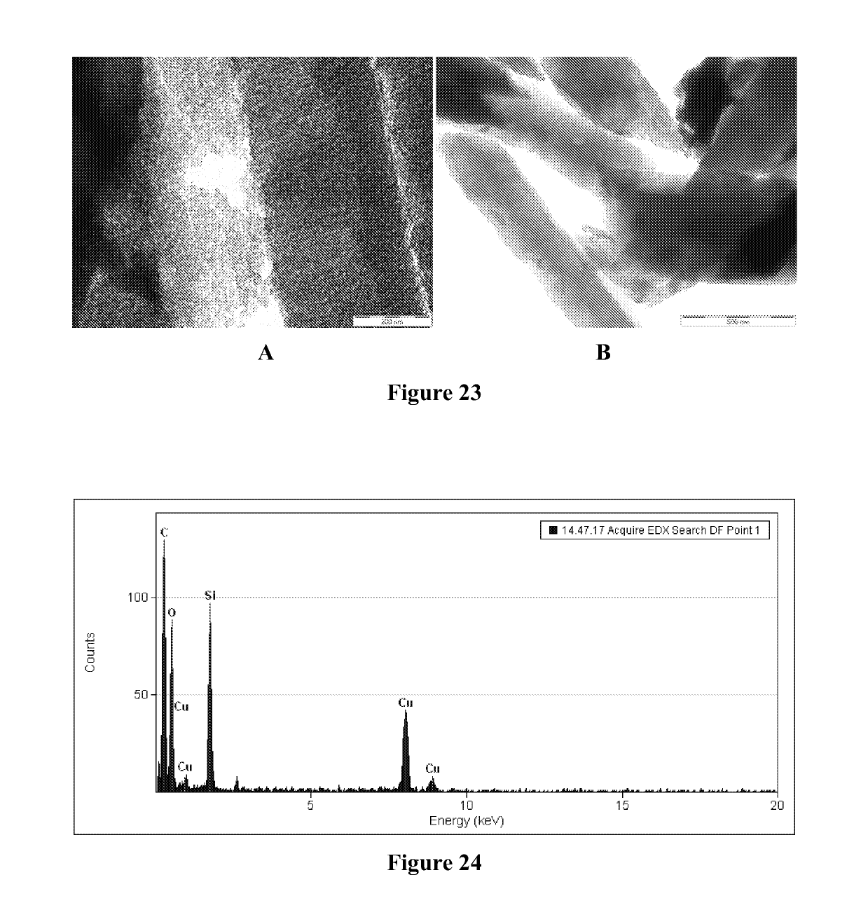

The fluid stock is also utilized to prepare nanostructured films. FIG. 23 illustrates nanostructured silica prepared using silicon acetate as the metal precursor. Panel A illustrates a material prepared from a mol Si (the moles of silicon in the silicon acetate):mol EO (the moles of ethylene oxide monomeric residue in the Pluronic-F127) of 0.476; panel B illustrates a material prepared from a mol Si:mol EO of 0.238. FIG. 24 illustrates the elemental analysis of such materials prepared with a mol Si:mol EO ratio of 0.476. Table 2 illustrates the pore diameters, and various surface area parameters of such materials:

TABLE 2

| Si acetate | F127 | EO | mol Si:mol | BET | BJH | Non-micropor | Micropor |
|---|---|---|---|---|---|---|---|
| (mol) | (mol) | (mol) | EO | (m2/g) | (Å) | area (m2/g) | area (m2/g) |
| 1.51E−03 | 1.59E−05 | 3.18E−03 | 0.476 | 623.77 | 37.58 | 541.26 | 82.51 |
| 1.51E−03 | 3.18E−05 | 6.36E−03 | 0.238 | 391.19 | 42.41 | 347.43 | 43.76 |

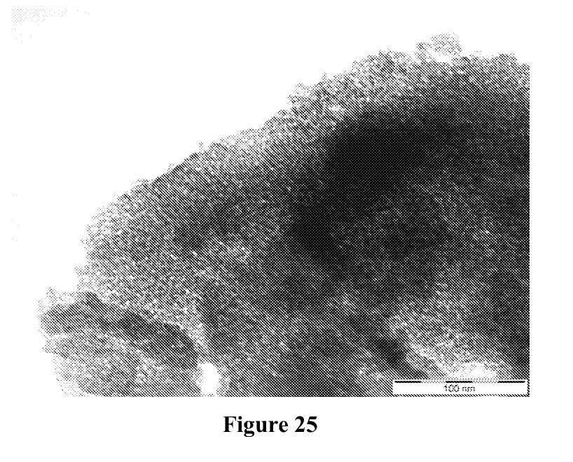

Similarly, FIG. 25 illustrates nanostructured alumina from aluminum acetate, with a mol Al:mol EO ratio of about 0.5. Table 3 illustrates the pore diameters, and various surface area parameters of such materials:

TABLE 3

| Al acetate | F127 | EO | mol Si:mol | BET | BJH | Non-micropor | Micropor |
|---|---|---|---|---|---|---|---|
| (mol) | (mol) | (mol) | EO | (m2/g) | (Å) | area (m2/g) | area (m2/g) |
| 2E−03 | 2E−03 | 4E−03 | 0.5 | 90 | 89 | 49 | 41 |

BET and BJH analyses are performed using a Gemini VII 2390+. A 1 g sample is placed into a test tube and de-gassed at 300 C for 3 hours using UHP nitrogen (99.9999% Nitrogen). The material is placed into the machine chamber, which is evacuated at 53.33 kPa for 5 min.

### Example 10

### Preparation of Mesoporous Nanostructures

Using an experimental similar to that in Example 8, a fluid stock is prepared from 0.75 g TEOS, 0.59 g PVP, and 5 g ethanol. The fluid stock is cast into films and electrospun into nanofibers and thermally treated to produce porous nanostructures.

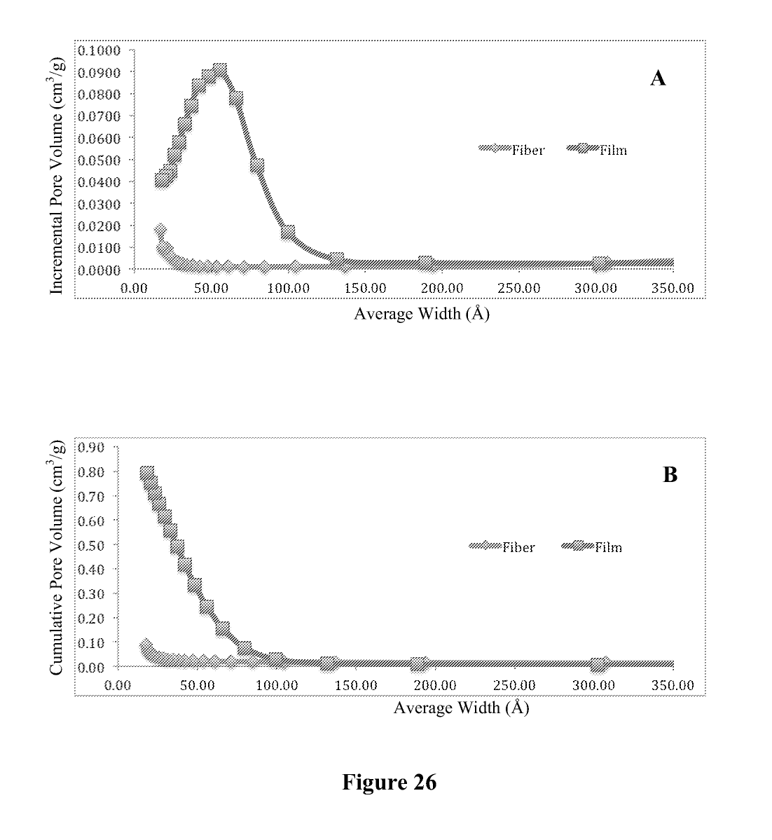

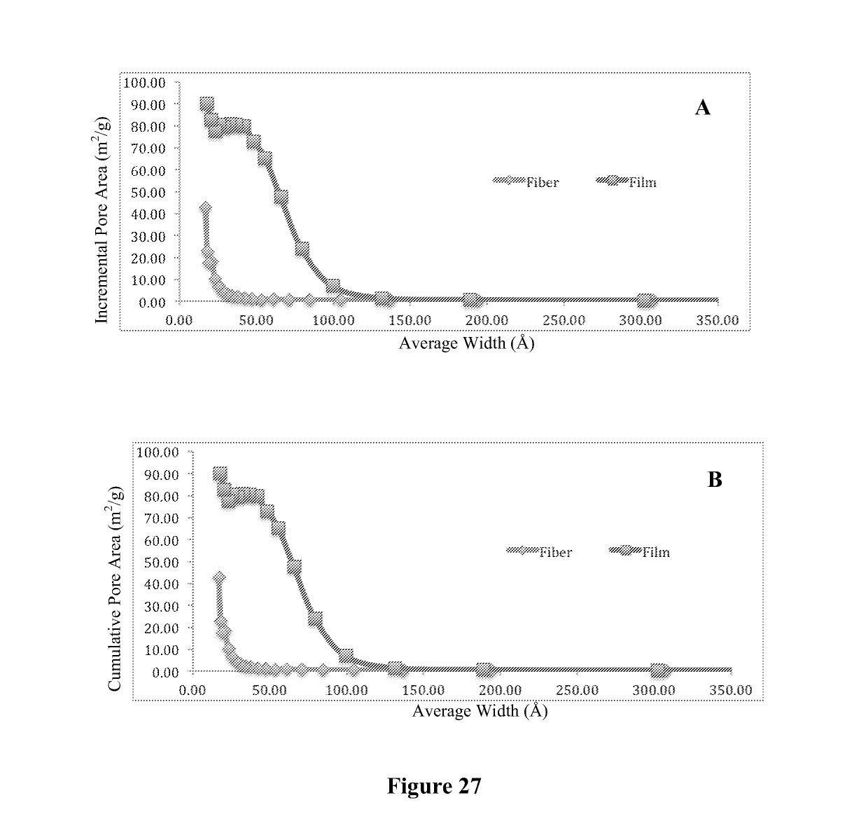

BET and BJH analyses are performed using a Gemini VII 2390+, according to the Examples described herein. FIG. 26 illustrates the incremental (panel A) and cumulative (panel B) pore volumes of the porous nanofibers and films. FIG. 27 illustrates the incremental (panel A) and cumulative (panel B) pore areas of the nanofibers and films.

Films and fibers are prepared from fluid stocks further comprising block copolymer (e.g., Pluronics P123 and F127). Table 4 illustrates the pore volumes and pore areas for nanofibers prepared using P123 and various pore sizes of such fibers. Table 5 illustrates the pore volumes and pore areas for nanofibers prepared using F127 and various pore sizes of such fibers.

TABLE 4

| Average | Incremental | Cumulative | Incremental | Cumulative |
|---|---|---|---|---|
| Width | Pore Volume | Pore Volume | Pore Area | Pore Area |
| (Å) | (cm³/g) | (cm³/g) | (m²/g) | (m²/g) |
| 602.30 | 0.0094 | 0.0094 | 0.63 | 0.63 |
| 308.17 | 0.0024 | 0.0118 | 0.31 | 0.94 |
| 193.28 | 0.0014 | 0.0132 | 0.28 | 1.22 |
| 135.81 | 0.0014 | 0.0145 | 0.40 | 1.62 |
| 103.66 | 0.0013 | 0.0158 | 0.48 | 2.10 |
| 83.60 | 0.0013 | 0.0171 | 0.63 | 2.73 |
| 69.78 | 0.0015 | 0.0186 | 0.87 | 3.60 |
| 59.70 | 0.0017 | 0.0204 | 1.17 | 4.77 |
| 52.02 | 0.0023 | 0.0227 | 1.80 | 6.57 |
| 45.88 | 0.0035 | 0.0262 | 3.05 | 9.62 |
| 40.83 | 0.0048 | 0.0310 | 4.70 | 14.32 |
| 36.58 | 0.0067 | 0.0377 | 7.34 | 21.65 |
| 32.93 | 0.0079 | 0.0457 | 9.64 | 31.29 |
| 29.74 | 0.0097 | 0.0554 | 13.10 | 44.40 |
| 26.88 | 0.0109 | 0.0663 | 16.23 | 60.62 |
| 24.27 | 0.0123 | 0.0787 | 20.35 | 80.98 |
| 21.81 | 0.0145 | 0.0932 | 26.61 | 107.58 |
| 19.42 | 0.0186 | 0.1118 | 38.29 | 145.88 |
| 17.78 | 0.0145 | 0.1262 | 32.59 | 178.46 |

TABLE 5

| Average | Incremental | Cumulative | Incremental | Cumulative |
|---|---|---|---|---|
| Width | Pore Volume | Pore Volume | Pore Area | Pore Area |
| (Å) | (cm³/g) | (cm³/g) | (m²/g) | (m²/g) |
| 575.35 | 0.0029 | 0.0029 | 0.20 | 0.20 |
| 305.56 | 0.0024 | 0.0053 | 0.31 | 0.51 |
| 190.90 | 0.0018 | 0.0071 | 0.38 | 0.90 |
| 133.33 | 0.0017 | 0.0088 | 0.51 | 1.40 |
| 101.36 | 0.0014 | 0.0102 | 0.56 | 1.97 |
| 81.39 | 0.0012 | 0.0115 | 0.61 | 2.58 |
| 67.76 | 0.0014 | 0.0129 | 0.82 | 3.39 |
| 57.60 | 0.0017 | 0.0145 | 1.16 | 4.56 |
| 49.96 | 0.0020 | 0.0165 | 1.60 | 6.16 |
| 43.84 | 0.0028 | 0.0194 | 2.57 | 8.73 |
| 38.80 | 0.0033 | 0.0226 | 3.36 | 12.08 |
| 34.57 | 0.0043 | 0.0269 | 4.93 | 17.02 |
| 30.91 | 0.0055 | 0.0324 | 7.13 | 24.14 |
| 27.71 | 0.0068 | 0.0392 | 9.86 | 34.00 |
| 24.85 | 0.0091 | 0.0483 | 14.68 | 48.68 |
| 22.25 | 0.0123 | 0.0607 | 22.17 | 70.85 |
| 19.79 | 0.0184 | 0.0791 | 37.27 | 108.12 |
| 17.40 | 0.0298 | 0.1089 | 68.45 | 176.57 |

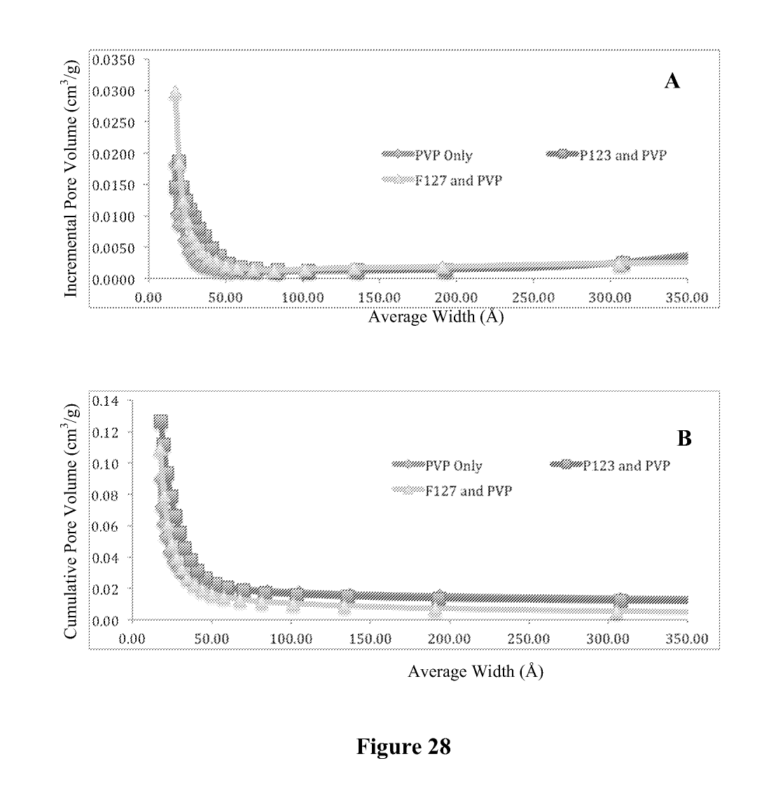

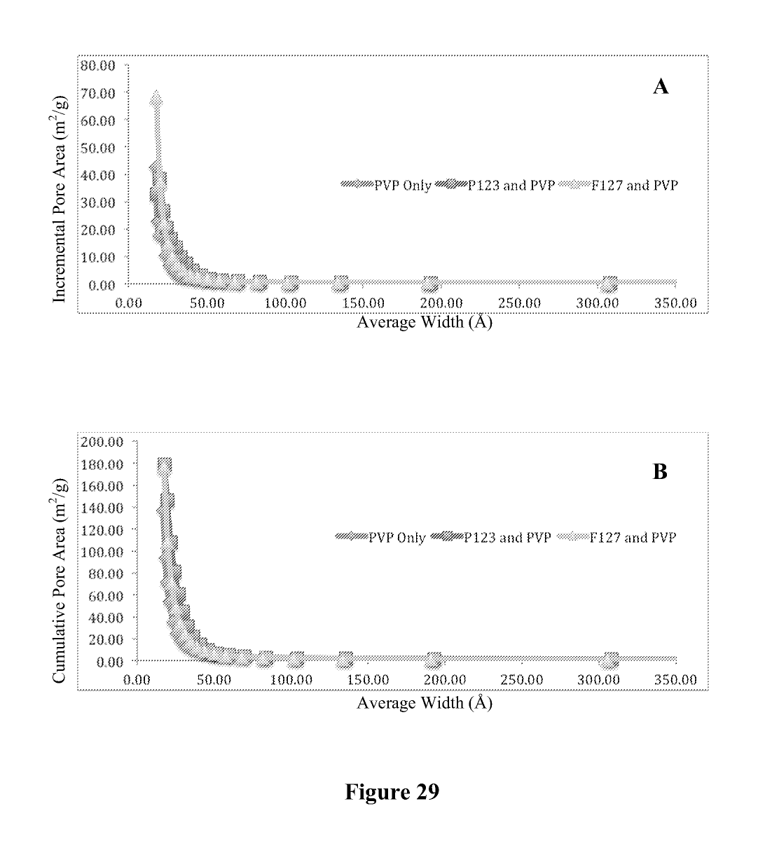

BET and BJH analyses are performed using a Gemini VII 2390+, according to the Examples described herein. FIG. 28 illustrates the incremental (panel A) and cumulative (panel B) pore volumes of the porous nanofibers prepared from a P123 containing fluid stock. FIG. 29 illustrates the incremental (panel A) and cumulative (panel B) pore areas of the nanofibers prepared from a F127 containing fluid stock. The specific surface area of the mesoporous nanofibers prepared from the P123 stock was measured to be 505.4 m²/g. The specific surface area of the mesoporous nanofibers prepared from the F127 stock was measured to be 632.0 m²/g.

What is claimed is:

1. A process for producing a mesoporous nanofiber, the process comprising:
a. electrospinning a fluid stock to produce a first (as-spun) nanofiber, the fluid stock comprising a block co-polymer; and
b. treating the first nanofiber to produce a mesoporous nanofiber.

2. The process of claim [1], wherein
a. the fluid stock comprises (a) at least one block co-polymer and (b) a metal precursor (e.g., a metal acetate for aqueous systems or metal alkoxide for sol gel systems), or
b. the fluid stock is prepared by combining (i) at least one block co-polymer, and (ii) a metal precursor.

3. The process of claim [2], wherein the mesoporous nanofiber is a mesoporous ceramic nanofiber comprising a continuous ceramic (e.g., silica, alumina, zirconia) matrix.

4. The process of claim [2], wherein the mesoporous nanofiber is a mesoporous metal nanofiber comprising a continuous metal matrix (e.g., a zero oxidation state metal, or metal alloy).

5. The process of claim [2], wherein the mesoporoous nanofiber is a mesoporoous metal oxide nanofiber comprising a continuous metal oxide matrix (e.g., comprising one or more type of metal).

6. The process of any one of the preceding claims, wherein the metal precursor comprises a metal halide, a metal carboxylate, a metal nitrate, a metal diketone, or a combination thereof.

7. The process of claim [6], wherein the metal precursor is silicon acetate, aluminum acetate, zirconium acetate, or silicon ethoxide.

8. The process of any one of the preceding claims, wherein the metal precursor comprises metal selected from the group consisting of: Ag, Cu, Ni, Fe, Co, Pb, Au, Sn, Al, Zr, Li, Mn, Cr, Be, Cd, Si, Ti, V, Hf, Sr, Ba, Ge, and combinations thereof.

9. The process of any one of the preceding claims, further comprising preparing the fluid stock by combining (i) at least one block co-polymer, (ii) a sol-gel precursor (e.g., TEOS), (iii) alcohol, and (iv) an optional acid (e.g., aqueous HCl).

10. The process of any one of the preceding claims, further comprising preparing the fluid stock by:
a. preparing a first stock by combining the metal precursor and a first aqueous composition (e.g., aqueous acetic acid);
b. preparing a second stock by (i) combining the at least one block co-polymer with a second aqueous composition (e.g., water), and (ii) optionally heating; and
c. combining the first and second stocks to form the fluid stock.

11. The process of any one of the preceding claims, wherein the metal precursor is present in or provided into the fluid stock in a concentration of at least 200 mM (e.g., at least 250 mM, or at least 300 mM).

12. The process of any one of the preceding claims, wherein the block co-polymer comprises at least one hydrophilic block, the at least one hydrophilic block comprising a plurality of hydrophilic monomeric residues, and the metal precursor being present in or added in a metal precursor-to-hydrophilic monomeric residue ratio of about 0.1 to about 4 (e.g., about 0.25 to about 1).

13. The process of any one of the preceding claims, wherein treating the first nanofiber comprises chemically treating the first nanofiber.

14. The process of any one of the preceding claims, wherein treating the first nanofiber comprises thermally treating the first nanofiber.

15. The process of any one of the preceding claims, wherein treating the first nanofiber comprises both chemically (e.g., with oxygen in an air atmosphere) and thermally treating the first nanofiber.

16. The process of any one of the preceding claims, wherein chemically and/or thermally treating the first nanofiber comprises thermally treating the first nanofiber at a temperature of at least 300° C.

17. The process of claim [16], wherein the thermal treatment of the first nanofiber is performed under oxidative conditions (e.g., air), producing a mesoporous metal oxide (e.g., metal oxide ceramic or non-ceramic) nanofiber.

18. The process of claim [16], wherein the thermal treatment of the first nanofiber is performed under inert or reducing conditions, producing a mesoporous metal nanofiber.

19. The process of claim [1], wherein chemically and/or thermally treating the first nanofiber comprises selectively removing at least part of the block co-polymer from the first nanofiber to create a mesoporous polymer nanofiber (e.g., by heating, by ozonolysis, by treating with an acid, by treating with a base, by treating with water, by combined assembly by soft and hard (CASH) chemistries, or any combination thereof).

20. The process of claim [19], further comprising thermally treating the mesoporous polymer nanofiber to provide a mesoporous carbon nanofiber.

21. The process of any one of the preceding claims, wherein the block co-polymer is amphiphilic (e.g., a surfactant).

22. The process of any one of the preceding claims, wherein the block copolymer comprises at least one hydrophilic block, and at least one hydrophobic or lipophilic block.

23. The process of any one of the preceding claims, wherein the bock co-polymer is a di-block or tri-block copolymer.

24. The process of any one of the preceding claims, wherein at least one block of the block co-polymer comprises monomeric residues comprising an alcohol, ether, amine, or combination thereof.

25. The process of any one of the preceding claims, wherein the block co-polymer comprises a polyvinyl alcohol (PVA) block, a polyethylene oxide (PEO) block, polyvinylpyridine block or any combination thereof.

26. The process of any one of the preceding claims, wherein the block co-polymer comprises a polyisoprene (PI) block, a polylactic acid (PLA) block, a polypropylene oxide (PPO) block, polystyrene (PS) block, a nylon block, polyacrylate block, polyacrylamide (PAA) block, polyvinylpyrrolidone (PVP) block, polyacrylonitrile (PAN), or any combination thereof.

27. The process of any one of the claims, wherein the block co-polymer comprises PI-b-PEO, PAN-b-PEO, PVA-b-PS, PEO-b-PPO-b-PEO, PPO-b-PEO-b-PPO, PVA-b-PEO, PVA-b-PAN, PVA-b-PPO, or any combination thereof.

28. The process of any one of the claims, wherein electrospinning is co-axially gas-assisted.

29. The process of any one of the preceding claims, wherein the fluid stock further comprises metal, ceramic, or metal oxide nanoparticles.

30. The process of any one of the preceding claims, wherein electrospinning the fluid stock comprises electrospinning the fluid stock with a carrier polymer.

31. The process of claim [30], wherein electrospinning the fluid stock comprises coaxially electrospinning the fluid stock with a second fluid stock, the second fluid stock comprising the carrier polymer (e.g., a polymer solution or a neat polymer melt, respectively).

32. The process of claim [30], wherein the fluid stock comprises the carrier polymer.

33. The process of any one of claims [30-32], wherein the carrier polymer is PVA, PAN or PVP.

34. The process of any one of claims [30-33], wherein the ratio of number (e.g., moles) of monomeric units of carrier polymer to number (e.g., moles) of metal precursor molecules is 1:1 to 10:1 (e.g., 2:1 to 5:1).

35. The process of any one of the preceding claims, wherein electrospinning the fluid stock comprises coaxially electrospinning the fluid stock with a second fluid stock, the second fluid stock comprising a coating agent or coating agent precursor, the first nanofiber comprising a core layer and a sheath layer, the core layer comprising the block co-polymer, and the sheath layer at least partially coating the core layer.

36. The process of claim [35], wherein the sheath layer comprises a thermally stable polymer, or a ceramic (e.g., silica from a second fluid stock comprising TEOS/EtOH/H₂O/HCl, with TEOS as the coating agent precursor).

37. The process of either one of claims [35-36], further comprising selectively removing the sheath layer (e.g., by heating, by ozonolysis, by treating with an acid, by treating with a base, by treating with water, by combined assembly by soft and hard (CASH) chemistries, or any combination thereof).

38. The process of any of the preceding claims, comprising annealing the first nanofiber (e.g., wherein annealing assembles the block co-polymers into ordered phase elements).

39. The process of claim [38], wherein the first nanofiber is annealed at a temperature of 50° C. to 200° C.

40. The process of claim [38], wherein annealing provides ordered phase elements comprising spheres, cylinders (i.e., rods), layers, channels, gyroids, or any combination thereof.

41. A nanofiber comprising a surface area of at least 10πrh, wherein r is the radius of the nanofiber and h is the length of the nanofiber.

42. A nanofiber comprising a specific surface area of at least 10 m²/g (e.g., at least 30 m²/g, at least 100 m²/g, at least 300 m²/g, at least 500 m²/g, or at least 1000 m²/g, e.g., as measured by BET).

43. A nanofiber comprising a porosity of at least 20% (e.g., at least 30%, at least 40%, at least 50%) and a length of at least 1 μm.

44. A nanofiber comprising a plurality of mesopores, the mesopores having an average (BJH) pore diameter of 2-25 nm.

45. A nanofiber comprising a plurality of mesopores and a maximum incremental non-microporous (i.e., <2 nm) pore volume at an average pore diameter of less than 25 nm (e.g., less than 20 nm, less than 10 nm, less than 7 nm, less than 5 nm).

46. A nanofiber comprising a plurality of mesopores, the mesopores having a substantially uniform size (e.g., at least 80% of the mesoporous incremental pore volume being from mesopores having a diameter within 5 nm (or 10 nm, 8 nm, 4 nm, 3 nm) of the mesopore diameter having the maximum incremental mesoporous pore volume).

47. A nanofiber comprising a plurality of mesopores, the mesopores ordered in a cubic-type morphology, hexagonal-type morphology, reverse hexagonal-type morphology, lamellar-type morphology, helical-type morphology, assembled micelle-type morphology, bi-continuous or a combination thereof.

48. The nanofiber of any one of the preceding claims, wherein comprising a plurality of mesopores, wherein the mesopores are distributed substantially uniformly throughout the nanofiber.

49. The nanofiber of any one of the preceding claims, comprising mesopores having spherical structures, cylindrical structures, layered structures, channel structures, or any combination thereof.

50. The nanofiber of any one of the preceding claims, the nanofiber comprising a continuous matrix of metal, metal oxide, or ceramic.

51. The nanofiber of any one of the preceding claims, the nanofiber comprising a continuous matrix of carbon or polymer.

52. The nanofiber of any one of the preceding claims, comprising a specific surface area of at least 10 m²/g (e.g., at least 30 m²/g, at least 100 m²/g, at least 300 m²/g, at least 500 m²/g, or at least 1000 m²/g, e.g., as measured by BET).

53. The nanofiber of any one of the preceding claims, comprising a porosity of at least 20% (e.g., at least 30%, at least 40%, at least 50%) and a length of at least 1 μm.

54. The nanofiber of any one of the preceding claims, comprising a plurality of mesopores, the mesopores having an average (BJH) pore diameter of 2-25 nm.

55. The nanofiber of any one of the preceding claims, comprising a plurality of mesopores and a maximum incremental non-microporous (i.e., <2 nm) pore volume at an average pore diameter of less than 25 nm (e.g., less than 20 nm, less than 10 nm, less than 7 nm, less than 5 nm).

56. The nanofiber of any one of the preceding claims, comprising a plurality of mesopores, at least 80% of the mesoporous incremental pore volume being from mesopores having a diameter within 10 nm of the mesopore diameter having the maximum incremental mesoporous pore volume.

57. The nanofiber of any one of the preceding claims, comprising a plurality of mesopores, at least 80% of the mesoporous incremental pore volume being from mesopores having a diameter within 10 nm (e.g., within 7 nm, within 3 nm) of the mesopore diameter having the maximum incremental mesoporous pore volume.

58. The nanofiber of any one of the preceding claims, comprising a plurality of mesopores, at least 80% of the mesoporous incremental pore volume being from mesopores having a diameter within 50% (e.g., within 33%, within 20%) of the size of the mesopore diameter having the maximum incremental mesoporous pore volume.

59. A nanofiber prepared according to a process of any one of claims 1-40.

60. A nanofiber of any of claims 41-58 prepared according to a process of any of claims 1-40.

61. A plurality of nanofibers having the characteristics, on average, of any one of claims 41-58.
